(19) United States
(12) Patent Application Publication
(10) Pub. No.: US 2021/0331587 A1
(43) Pub. Date: Oct. 28, 2021

(54) METHOD OF DISPLAYING DRIVING SITUATION OF VEHICLE BY SENSING DRIVER'S GAZE AND APPARATUS FOR SAME

(71) Applicant: LG ELECTRONICS INC., Seoul (KR)

(72) Inventor: Namjoon Kim, Seoul (KR)

(73) Assignee: LG ELECTRONICS INC., Seoul (KR)

(21) Appl. No.: 16/493,218

(22) PCT Filed: Jul. 5, 2019
(86) PCT No.: PCT/KR2019/008291

§ 371 Date: Sep. 11, 2019

(51) Int. Cl. B60K 35/00; G06F 3/01; B60R 11/02; B60R 11/04

(52) U.S. Cl. CPC B60K 35/00; G06F 3/013; B60R 11/0235; B60R 11/04; B60R 2300/8093; B60K 2370/152; B60K 2370/178; B60R 2300/60; B60K 2370/149

(57) ABSTRACT

The present disclosure provides a method of displaying a vehicle driving situation. In detail, the method of displaying a vehicle driving situation includes: sensing a position of a UE (User Equipment) through a first camera installed in a vehicle; acquiring in real time a surrounding outside image of the vehicle through a second camera installed in the vehicle; sensing a gaze direction of a driver through a third camera installed in the vehicle; receiving the outside image by means of the UE; and displaying a first image including the outside image on a screen of the UE, in which the first image is displayed when the UE is positioned in the gaze direction of the driver.

### TECHNICAL FIELD

The present disclosure relates to a method and system for displaying a driving situation of a vehicle and apparatus for the method, and more particularly, to a method of displaying a driving situation of a vehicle by sensing a driver's gaze and an apparatus for supporting the method.

### BACKGROUND ART

Due to expansion of popularization of mobile devices, in a situation with frequent driving accidents due to mobile devices, methods and apparatuses for solving this problem have been required.

Due to a notice from a mobile device during driving, the driver's gaze moves to the mobile device, and due to a problem such as careless paying attention to the road, many sudden accidents occur, so various methods for solving this problem have bee studied.

### DISCLOSURE

### Technical Problem

An object of the present disclosure is to provide a method of displaying a driving state of a vehicle.

Further, an object of the present disclosure is to provide a method in which an apparatus linked with a vehicle senses a driver's gaze and a driving state of the vehicle is displayed on the apparatus.

Further, an object of the present disclosure is to provide a method of highlighting and displaying a specific dangerous situation on an apparatus linked with a vehicle when the specific dangerous situation occurs during driving.

Technical problems to be achieved in the present disclosure are not limited to the above-mentioned technical problems, and other technical problems not mentioned will be clearly understood by those skilled in the art from the following description.

### Technical Solution

The present disclosure provides a method in which a system linked with a vehicle senses a driver's gaze and displays a driving situation of the vehicle on the system.

In detail, the method of displaying a vehicle driving situation includes: sensing a position of a UE (User Equipment) through a first camera installed in a vehicle; acquiring in real time a surrounding outside image of the vehicle through a second camera installed in the vehicle; sensing a gaze direction of a driver through a third camera installed in the vehicle; receiving the outside image by means of the UE; and displaying a first image including the outside image on a screen of the UE, in which the first image is displayed when the UE is positioned in the gaze direction of the driver.

Further, in the present disclosure, the outside image that is displayed on the screen of the UE includes at least one of a front image, a side image, or a rear image of the vehicle.

Further, in the present disclosure, the outside image that is displayed on the screen of the UE is determined in accordance with a driving direction of the vehicle.

Further, in the present disclosure, the first image further includes an application execution image of the UE, and the outside image and the application execution image of the UE are simultaneously displayed with different transparencies.

Further, in the present disclosure, the first image further includes an application execution image of the UE, and when the UE has a plurality of screens, the outside image is displayed on a first screen of the UE and the application execution image of the UE is displayed on a second screen.

Further, in the present disclosure, the UE is operated in any one of a first state displaying the first image and a second state that is an idle state, and when it is sensed that the gaze direction of the driver is directed to the UE, the UE operates in the first state.

Further, in the present disclosure, the receiving the outside image by means of the UE include: transmitting the outside image to a server by means of the second camera; and receiving the outside image and a second image transmitted by another vehicle from the server by means of the UE, in which the first image further includes the second image.

Further, in the present disclosure, the method may further include additionally displaying a predetermined dangerous situation in the first image on the screen of the UE using a predetermined expression when the dangerous situation is sensed.

Further, in the present disclosure, the sensing of a position of a UE through a first camera installed in a vehicle further includes sensing whether a direction of the screen of the UE is directed to the driver.

Further, in the present disclosure, a system for displaying a vehicle driving situation includes: a vehicle including a first camera sensing a position of a UE (User Equipment), a second camera acquiring in real time an outside image of the vehicle, and a third camera sensing a gaze direction of the driver; and the UE receiving the outside image and displaying in real time a first image including the outside image on a screen of the UE, in which the first image is displayed when the UE is positioned in the gaze direction of the driver.

Further, in the present disclosure, the outside image that is displayed on the screen of the UE includes at least one of a front image, a side image, or a rear image of the vehicle.

Further, in the present disclosure, the outside image that is displayed on the screen of the UE is determined in accordance with a driving direction of the vehicle.

Further, in the present disclosure, the first image further includes an application execution image of the UE, and the outside image and the application execution image of the UE are simultaneously displayed with different transparencies.

Further, in the present disclosure, the first image further includes an application execution image of the UE, and when the UE has a plurality of screens, the outside image is displayed on a first screen of the UE and the application execution image of the UE is displayed on a second screen.

Further, in the present disclosure, the UE is operated in any one of a first state displaying the first image and a second state that is an idle state, and when it is sensed that the gaze direction of the driver is directed to the UE, the UE operates in the first state.

Further, in the present disclosure, the system further includes a server receiving the outside image and a second image transmitted by another vehicle from the second camera, in which the UE is the UE that receives the outside image and the second image from the server and displays a first image including the outside image and the second image on the screen of the UE.

Further, in the present disclosure, the UE additionally displays a predetermined dangerous situation in the first image on the screen of the UE using a predetermined expression when the dangerous situation is sensed.

Further, in the present disclosure, the first camera is a camera that senses whether the position of the UE and the direction of the screen of the UE are directed to the driver.

Further, in the present disclosure, a method of displaying a vehicle driving situation includes: performing an initial access procedure with a vehicle by periodically transmitting an SSB (Synchronization Signal Block); performing a random access procedure with the vehicle; transmitting an uplink grant (UP grant) to the vehicle to schedule transmission of an outside image of the vehicle; transmitting the outside image of the vehicle to a UE (User Equipment) on the basis of the uplink grant; and displaying in real time a first image including the outside image of the vehicle on a screen of the UE, in which the first image is displayed when the UE is positioned in a gaze direction of a driver.

Further, in the present disclosure, the method further includes performing a downlink beam management (DL Beam Management) procedure using the SSB.

### Advantageous Effects

In the present disclosure, an apparatus linked with a vehicle senses a driver's gaze and displays a driving situation of the vehicle, there is an effect in that it is possible to prepare against a sudden dangerous situation.

Further, there is an effect in that by highlighting and displaying a specific dangerous situation that may occur while a vehicle is driven, a driver can quickly recognize the dangerous situation.

Effects obtained in the present disclosure are not limited to the above-mentioned technical problems, and other effects not mentioned will be clearly understood by those skilled in the art from the following description.

### DESCRIPTION OF DRAWINGS

Accompanying drawings included as a part of the detailed description for helping understand the present disclosure provide embodiments of the present disclosure and are provided to describe technical features of the present disclosure with the detailed description.

FIG. 1 is a block diagram of a wireless communication system to which methods proposed in the disclosure are applicable.

FIG. 2 shows an example of a signal transmission/reception method in a wireless communication system.

FIG. 3 shows an example of basic operations of an autonomous vehicle and a 5G network in a 5G communication system.

FIGS. 4 to 7 show an example of the operation of the autonomous vehicle using 5G communication.

FIG. 8 is a diagram showing a signal flow in an autonomous vehicle according to an embodiment of the present disclosure.

FIG. 9 is a diagram illustrating the interior of a vehicle according to an embodiment of the present disclosure.

FIG. 10 is a block diagram referred to in description of a cabin system for a vehicle according to an embodiment of the present disclosure.

FIG. 11 is a diagram referred to in description of a usage scenario of a user according to an embodiment of the present disclosure.

FIG. 12 shows various scenarios of sidelink.

FIG. 13 shows a protocol stack of sidelink.

FIG. 14 shows a control plane protocol stack of sidelink.

FIG. 15 shows an example of a signaling transmission/reception method in a sidelink communication Mode1/Mode 3.

FIG. 16 shows an example of downlink control information transmission for slidelink communication.

FIG. 17 shows an example of types of V2X applications.

FIG. 18 is an example of a system configuration diagram to which a method proposed in the present disclosure can be applied.

FIG. 19 is a diagram showing an embodiment of sensing a gaze direction of a driver to which a method proposed in the present disclosure is applied.

FIG. 20 is a diagram showing an example of displaying a driving situation proposed in the present disclosure on the screen of a UE.

FIG. 21 is a diagram showing an example of dangerous situation expression displayed on a UE in which a method proposed in the present disclosure is performed.

FIG. 22 is a diagram showing an embodiment to which a method proposed in the present disclosure is applied.

FIG. 23 is a flowchart showing a method of converting the operation state of a UE of the present disclosure.

FIG. 24 is a diagram showing another embodiment of the method of converting the operation state of a UE of the present disclosure.

### MODE FOR INVENTION

Hereinafter, embodiments of the disclosure will be described in detail with reference to the attached drawings. The same or similar components are given the same reference numbers and redundant description thereof is omitted. The suffixes “module” and “unit” of elements herein are used for convenience of description and thus can be used interchangeably and do not have any distinguishable meanings or functions. Further, in the following description, if a detailed description of known techniques associated with the present disclosure would unnecessarily obscure the gist of the present disclosure, detailed description thereof will be omitted. In addition, the attached drawings are provided for easy understanding of embodiments of the disclosure and do not limit technical spirits of the disclosure, and the embodiments should be construed as including all modifications, equivalents, and alternatives falling within the spirit and scope of the embodiments.

While terms, such as “first”, “second”, etc., may be used to describe various components, such components must not be limited by the above terms. The above terms are used only to distinguish one component from another.

When an element is “coupled” or “connected” to another element, it should be understood that a third element may be present between the two elements although the element may be directly coupled or connected to the other element.

When an element is “directly coupled” or “directly connected” to another element, it should be understood that no element is present between the two elements.

The singular forms are intended to include the plural forms as well, unless the context clearly indicates otherwise.

In addition, in the specification, it will be further understood that the terms “comprise” and “include” specify the presence of stated features, integers, steps, operations, elements, components, and/or combinations thereof, but do not preclude the presence or addition of one or more other features, integers, steps, operations, elements, components, and/or combinations.

A. Example of Block Diagram of UE and 5G Network

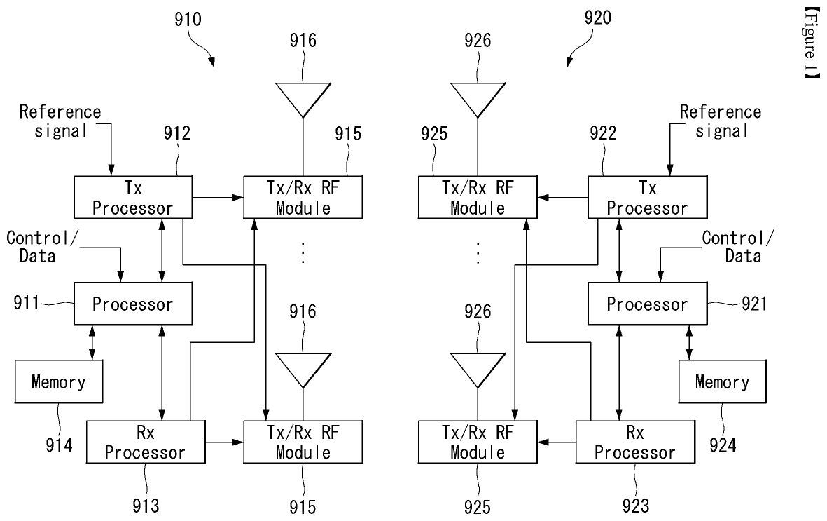

FIG. 1 is a block diagram of a wireless communication system to which methods proposed in the disclosure are applicable.

Referring to FIG. 1, a device (autonomous device) including an autonomous module is defined as a first communication device (910 of FIG. 1), and a processor 911 can perform detailed autonomous operations.

A 5G network including another vehicle communicating with the autonomous device is defined as a second communication device (920 of FIG. 1), and a processor 921 can perform detailed autonomous operations.

The 5G network may be represented as the first communication device and the autonomous device may be represented as the second communication device.

For example, the first communication device or the second communication device may be a base station, a network node, a transmission terminal, a reception terminal, a wireless device, a wireless communication device, an autonomous device, or the like.

For example, a terminal or user equipment (UE) may include a vehicle, a cellular phone, a smart phone, a laptop computer, a digital broadcast terminal, personal digital assistants (PDAs), a portable multimedia player (PMP), a navigation device, a slate PC, a tablet PC, an ultrabook, a wearable device (e.g., a smartwatch, a smart glass and a head mounted display (HMD)), etc. For example, the HMD may be a display device worn on the head of a user. For example, the HMD may be used to realize VR, AR or MR. Referring to FIG. 1, the first communication device 910 and the second communication device 920 include processors 911 and 921, memories 914 and 924, one or more Tx/Rx radio frequency (RF) modules 915 and 925, Tx processors 912 and 922, Rx processors 913 and 923, and antennas 916 and 926. The Tx/Rx module is also referred to as a transceiver. Each Tx/Rx module 915 transmits a signal through each antenna 926. The processor implements the aforementioned functions, processes and/or methods. The processor 921 may be related to the memory 924 that stores program code and data. The memory may be referred to as a computer-readable medium. More specifically, the Tx processor 912 implements various signal processing functions with respect to L1 (i.e., physical layer) in DL (communication from the first communication device to the second communication device). The Rx processor implements various signal processing functions of L1 (i.e., physical layer).

UL (communication from the second communication device to the first communication device) is processed in the first communication device 910 in a way similar to that described in association with a receiver function in the second communication device 920. Each Tx/Rx module 925 receives a signal through each antenna 926. Each Tx/Rx module provides RF carriers and information to the Rx processor 923. The processor 921 may be related to the memory 924 that stores program code and data. The memory may be referred to as a computer-readable medium.

B. Signal Transmission/Reception Method in Wireless Communication System

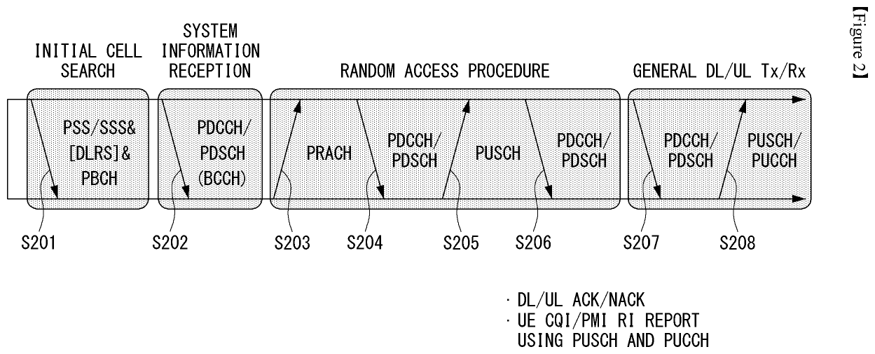

FIG. 2 is a diagram showing an example of a signal transmission/reception method in a wireless communication system.

Referring to FIG. 2, when a UE is powered on or enters a new cell, the UE performs an initial cell search operation such as synchronization with a BS (S201). For this operation, the UE can receive a primary synchronization channel (P-SCH) and a secondary synchronization channel (S-SCH) from the BS to synchronize with the BS and acquire information such as a cell ID. In LTE and NR systems, the P-SCH and S-SCH are respectively called a primary synchronization signal (PSS) and a secondary synchronization signal (SSS). After initial cell search, the UE can acquire broadcast information in the cell by receiving a physical broadcast channel (PBCH) from the BS. Further, the UE can receive a downlink reference signal (DL RS) in the initial cell search step to check a downlink channel state. After initial cell search, the UE can acquire more detailed system information by receiving a physical downlink shared channel (PDSCH) according to a physical downlink control channel (PDCCH) and information included in the PDCCH (S202).

Meanwhile, when the UE initially accesses the BS or has no radio resource for signal transmission, the UE can perform a random access procedure (RACH) for the BS (steps S203 to S206). To this end, the UE can transmit a specific sequence as a preamble through a physical random access channel (PRACH) (S203 and S205) and receive a random access response (RAR) message for the preamble through a PDCCH and a corresponding PDSCH (S204 and S206). In the case of a contention-based RACH, a contention resolution procedure may be additionally performed.

After the UE performs the above-described process, the UE can perform PDCCH/PDSCH reception (S207) and physical uplink shared channel (PUSCH)/physical uplink control channel (PUCCH) transmission (S208) as normal uplink/downlink signal transmission processes. Particularly, the UE receives downlink control information (DCI) through the PDCCH. The UE monitors a set of PDCCH candidates in monitoring occasions set for one or more control element sets (CORESET) on a serving cell according to corresponding search space configurations. A set of PDCCH candidates to be monitored by the UE is defined in terms of search space sets, and a search space set may be a common search space set or a UE-specific search space set. CORESET includes a set of (physical) resource blocks having a duration of one to three OFDM symbols. A network can configure the UE such that the UE has a plurality of CORESETs. The UE monitors PDCCH candidates in one or more search space sets. Here, monitoring means attempting decoding of PDCCH candidate(s) in a search space. When the UE has successfully decoded one of PDCCH candidates in a search space, the UE determines that a PDCCH has been detected from the PDCCH candidate and performs PDSCH reception or PUSCH transmission on the basis of DCI in the detected PDCCH. The PDCCH can be used to schedule DL transmissions over a PDSCH and UL transmissions over a PUSCH. Here, the DCI in the PDCCH includes downlink assignment (i.e., downlink grant (DL grant)) related to a physical downlink shared channel and including at least a modulation and coding format and resource allocation information, or an uplink grant (UL grant) related to a physical uplink shared channel and including a modulation and coding format and resource allocation information.

An initial access (IA) procedure in a 5G communication system will be additionally described with reference to FIG. 2.

The UE can perform cell search, system information acquisition, beam alignment for initial access, and DL measurement on the basis of an SSB. The SSB is interchangeably used with a synchronization signal/physical broadcast channel (SS/PBCH) block.

The SSB includes a PSS, an SSS and a PBCH. The SSB is configured in four consecutive OFDM symbols, and a PSS, a PBCH, an SSS/PBCH or a PBCH is transmitted for each OFDM symbol. Each of the PSS and the SSS includes one OFDM symbol and 127 subcarriers, and the PBCH includes 3 OFDM symbols and 576 subcarriers.

Cell search refers to a process in which a UE acquires time/frequency synchronization of a cell and detects a cell identifier (ID) (e.g., physical layer cell ID (PCI)) of the cell. The PSS is used to detect a cell ID in a cell ID group and the SSS is used to detect a cell ID group. The PBCH is used to detect an SSB (time) index and a half-frame.

There are 336 cell ID groups and there are 3 cell IDs per cell ID group. A total of 1008 cell IDs are present. Information on a cell ID group to which a cell ID of a cell belongs is provided/acquired through an SSS of the cell, and information on the cell ID among 336 cell ID groups is provided/acquired through a PSS.

The SSB is periodically transmitted in accordance with SSB periodicity. A default SSB periodicity assumed by a UE during initial cell search is defined as 20 ms. After cell access, the SSB periodicity can be set to one of {5 ms, 10 ms, 20 ms, 40 ms, 80 ms, 160 ms} by a network (e.g., a BS).

Next, acquisition of system information (SI) will be described.

SI is divided into a master information block (MIB) and a plurality of system information blocks (SIBs). SI other than the MIB may be referred to as remaining minimum system information. The MIB includes information/parameter for monitoring a PDCCH that schedules a PDSCH carrying SIB1 (SystemInformationBlock1) and is transmitted by a BS through a PBCH of an SSB. SIB1 includes information related to availability and scheduling (e.g., transmission periodicity and SI-window size) of the remaining SIBs (hereinafter, SIBx, x is an integer equal to or greater than 2). SiBx is included in an SI message and transmitted over a PDSCH. Each SI message is transmitted within a periodically generated time window (i.e., SI-window).

A random access (RA) procedure in a 5G communication system will be additionally described with reference to FIG. 2.

A random access procedure is used for various purposes. For example, the random access procedure can be used for network initial access, handover, and UE-triggered UL data transmission. A UE can acquire UL synchronization and UL transmission resources through the random access procedure. The random access procedure is classified into a contention-based random access procedure and a contention-free random access procedure. A detailed procedure for the contention-based random access procedure is as follows.

A UE can transmit a random access preamble through a PRACH as Msg1 of a random access procedure in UL. Random access preamble sequences having different two lengths are supported. A long sequence length 839 is applied to subcarrier spacings of 1.25 kHz and 5 kHz and a short sequence length 139 is applied to subcarrier spacings of 15 kHz, 30 kHz, 60 kHz and 120 kHz.

When a BS receives the random access preamble from the UE, the BS transmits a random access response (RAR) message (Msg2) to the UE. A PDCCH that schedules a PDSCH carrying a RAR is CRC masked by a random access (RA) radio network temporary identifier (RNTI) (RA-RNTI) and transmitted. Upon detection of the PDCCH masked by the RA-RNTI, the UE can receive a RAR from the PDSCH scheduled by DCI carried by the PDCCH. The UE checks whether the RAR includes random access response information with respect to the preamble transmitted by the UE, that is, Msg1. Presence or absence of random access information with respect to Msg1 transmitted by the UE can be determined according to presence or absence of a random access preamble ID with respect to the preamble transmitted by the UE. If there is no response to Msg1, the UE can retransmit the RACH preamble less than a predetermined number of times while performing power ramping. The UE calculates PRACH transmission power for preamble retransmission on the basis of most recent pathloss and a power ramping counter.

The UE can perform UL transmission through Msg3 of the random access procedure over a physical uplink shared channel on the basis of the random access response information. Msg3 can include an RRC connection request and a UE ID. The network can transmit Msg4 as a response to Msg3, and Msg4 can be handled as a contention resolution message on DL. The UE can enter an RRC connected state by receiving Msg4.

C. Beam Management (BM) Procedure of 5G Communication System

A BM procedure can be divided into (1) a DL MB procedure using an SSB or a CSI-RS and (2) a UL BM procedure using a sounding reference signal (SRS). In addition, each BM procedure can include Tx beam swiping for determining a Tx beam and Rx beam swiping for determining an Rx beam.

The DL BM procedure using an SSB will be described.

Configuration of a beam report using an SSB is performed when channel state information (CSI)/beam is configured in RRC_CONNECTED.
A UE receives a CSI-ResourceConfig IE including CSI-SSB-ResourceSetList for SSB resources used for BM from a BS. The RRC parameter “csi-SSB-ResourceSetList” represents a list of SSB resources used for beam management and report in one resource set. Here, an SSB resource set can be set as {SSBx1, SSBx2, SSBx3, SSBx4, . . . }. An SSB index can be defined in the range of 0 to 63.
The UE receives the signals on SSB resources from the BS on the basis of the CSI-SSB-ResourceSetList.
When CSI-RS reportConfig with respect to a report on SSBRI and reference signal received power (RSRP) is set, the UE reports the best SSBRI and RSRP corresponding thereto to the BS. For example, when reportQuantity of the CSI-RS reportConfig IE is set to ‘ssb-Index-RSRP’, the UE reports the best SSBRI and RSRP corresponding thereto to the BS.

When a CSI-RS resource is configured in the same OFDM symbols as an SSB and ‘QCL-TypeD’ is applicable, the UE can assume that the CSI-RS and the SSB are quasi co-located (QCL) from the viewpoint of ‘QCL-TypeD’. Here, QCL-TypeD may mean that antenna ports are quasi co-located from the viewpoint of a spatial Rx parameter. When the UE receives signals of a plurality of DL antenna ports in a QCL-TypeD relationship, the same Rx beam can be applied.

Next, a DL BM procedure using a CSI-RS will be described.

An Rx beam determination (or refinement) procedure of a UE and a Tx beam swiping procedure of a BS using a CSI-RS will be sequentially described. A repetition parameter is set to ‘ON’ in the Rx beam determination procedure of a UE and set to ‘OFF’ in the Tx beam swiping procedure of a BS.

First, the Rx beam determination procedure of a UE will be described.
The UE receives an NZP CSI-RS resource set IE including an RRC parameter with respect to ‘repetition’ from a BS through RRC signaling. Here, the RRC parameter ‘repetition’ is set to ‘ON’.
The UE repeatedly receives signals on resources in a CSI-RS resource set in which the RRC parameter ‘repetition’ is set to ‘ON’ in different OFDM symbols through the same Tx beam (or DL spatial domain transmission filters) of the BS.
The UE determines an RX beam thereof.
The UE skips a CSI report. That is, the UE can skip a CSI report when the RRC parameter ‘repetition’ is set to ‘ON’.

Next, the Tx beam determination procedure of a BS will be described.
A UE receives an NZP CSI-RS resource set IE including an RRC parameter with respect to ‘repetition’ from the BS through RRC signaling. Here, the RRC parameter ‘repetition’ is related to the Tx beam swiping procedure of the BS when set to ‘OFF’.
The UE receives signals on resources in a CSI-RS resource set in which the RRC parameter ‘repetition’ is set to ‘OFF’ in different DL spatial domain transmission filters of the BS.
The UE selects (or determines) a best beam.
The UE reports an ID (e.g., CRI) of the selected beam and related quality information (e.g., RSRP) to the BS. That is, when a CSI-RS is transmitted for BM, the UE reports a CRI and RSRP with respect thereto to the BS.

Next, the UL BM procedure using an SRS will be described.
A UE receives RRC signaling (e.g., SRS-Config IE) including a (RRC parameter) purpose parameter set to ‘beam management” from a BS. The SRS-Config IE is used to set SRS transmission. The SRS-Config IE includes a list of SRS-Resources and a list of SRS-ResourceSets. Each SRS resource set refers to a set of SRS-resources.

The UE determines Tx beamforming for SRS resources to be transmitted on the basis of SRS-SpatialRelation Info included in the SRS-Config IE. Here, SRS-SpatialRelation Info is set for each SRS resource and indicates whether the same beamforming as that used for an SSB, a CSI-RS or an SRS will be applied for each SRS resource.
When SRS-SpatialRelationInfo is set for SRS resources, the same beamforming as that used for the SSB, CSI-RS or SRS is applied. However, when SRS-SpatialRelationInfo is not set for SRS resources, the UE arbitrarily determines Tx beamforming and transmits an SRS through the determined Tx beamforming.

Next, a beam failure recovery (BFR) procedure will be described.

In a beamformed system, radio link failure (RLF) may frequently occur due to rotation, movement or beamforming blockage of a UE. Accordingly, NR supports BFR in order to prevent frequent occurrence of RLF. BFR is similar to a radio link failure recovery procedure and can be supported when a UE knows new candidate beams. For beam failure detection, a BS configures beam failure detection reference signals for a UE, and the UE declares beam failure when the number of beam failure indications from the physical layer of the UE reaches a threshold set through RRC signaling within a period set through RRC signaling of the BS. After beam failure detection, the UE triggers beam failure recovery by initiating a random access procedure in a PCell and performs beam failure recovery by selecting a suitable beam. (When the BS provides dedicated random access resources for certain beams, these are prioritized by the UE). Completion of the aforementioned random access procedure is regarded as completion of beam failure recovery.

D. URLLC (Ultra-Reliable and Low Latency Communication)

URLLC transmission defined in NR can refer to (1) a relatively low traffic size, (2) a relatively low arrival rate, (3) extremely low latency requirements (e.g., 0.5 and 1 ms), (4) relatively short transmission duration (e.g., 2 OFDM symbols), (5) urgent services/messages, etc. In the case of UL, transmission of traffic of a specific type (e.g., URLLC) needs to be multiplexed with another transmission (e.g., eMBB) scheduled in advance in order to satisfy more stringent latency requirements. In this regard, a method of providing information indicating preemption of specific resources to a UE scheduled in advance and allowing a URLLC UE to use the resources for UL transmission is provided.

NR supports dynamic resource sharing between eMBB and URLLC. eMBB and URLLC services can be scheduled on non-overlapping time/frequency resources, and URLLC transmission can occur in resources scheduled for ongoing eMBB traffic. An eMBB UE may not ascertain whether PDSCH transmission of the corresponding UE has been partially punctured and the UE may not decode a PDSCH due to corrupted coded bits. In view of this, NR provides a preemption indication. The preemption indication may also be referred to as an interrupted transmission indication.

With regard to the preemption indication, a UE receives DownlinkPreemption IE through RRC signaling from a BS. When the UE is provided with DownlinkPreemption IE, the UE is configured with INT-RNTI provided by a parameter int-RNTI in DownlinkPreemption IE for monitoring of a PDCCH that conveys DCI format 2_1. The UE is additionally configured with a corresponding set of positions for fields in DCI format 2_1 according to a set of serving cells and positionInDCI by INT-ConfigurationPerServing Cell including a set of serving cell indexes provided by servingCellID, configured having an information payload size for DCI format 2_1 according to dci-Payloadsize, and configured with indication granularity of time-frequency resources according to timeFrequencySect.

The UE receives DCI format 2_1 from the BS on the basis of the DownlinkPreemption IE.

When the UE detects DCI format 2_1 for a serving cell in a configured set of serving cells, the UE can assume that there is no transmission to the UE in PRBs and symbols indicated by the DCI format 2_1 in a set of PRBs and a set of symbols in a last monitoring period before a monitoring period to which the DCI format 2_1 belongs. For example, the UE assumes that a signal in a time-frequency resource indicated according to preemption is not DL transmission scheduled therefor and decodes data on the basis of signals received in the remaining resource region.

E. mMTC (Massive MTC)

mMTC (massive Machine Type Communication) is one of 5G scenarios for supporting a hyper-connection service providing simultaneous communication with a large number of UEs. In this environment, a UE intermittently performs communication with a very low speed and mobility. Accordingly, a main goal of mMTC is operating a UE for a long time at a low cost. With respect to mMTC, 3GPP deals with MTC and NB (NarrowBand)-IoT.

mMTC has features such as repetitive transmission of a PDCCH, a PUCCH, a PDSCH (physical downlink shared channel), a PUSCH, etc., frequency hopping, retuning, and a guard period.

That is, a PUSCH (or a PUCCH (particularly, a long PUCCH) or a PRACH) including specific information and a PDSCH (or a PDCCH) including a response to the specific information are repeatedly transmitted. Repetitive transmission is performed through frequency hopping, and for repetitive transmission, (RF) retuning from a first frequency resource to a second frequency resource is performed in a guard period and the specific information and the response to the specific information can be transmitted/received through a narrowband (e.g., 6 resource blocks (RBs) or 1 RB).

F. Basic Operation Between Autonomous Vehicles Using 5G Communication

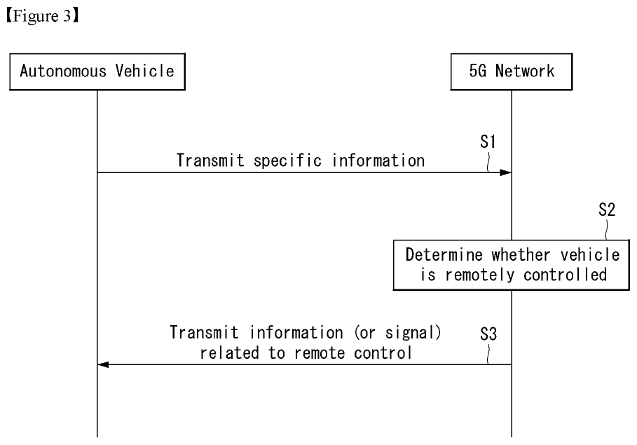

FIG. 3 shows an example of basic operations of an autonomous vehicle and a 5G network in a 5G communication system.

The autonomous vehicle transmits specific information to the 5G network (S1). The specific information may include autonomous driving related information. In addition, the 5G network can determine whether to remotely control the vehicle (S2). Here, the 5G network may include a server or a module which performs remote control related to autonomous driving. In addition, the 5G network can transmit information (or signal) related to remote control to the autonomous vehicle (S3).

G. Applied Operations Between Autonomous Vehicle and 5G Network in 5G Communication System

Hereinafter, the operation of an autonomous vehicle using 5G communication will be described in more detail with reference to wireless communication technology (BM procedure, URLLC, mMTC, etc.) described in FIGS. 1 and 2.

First, a basic procedure of an applied operation to which a method proposed by the present disclosure which will be described later and eMBB of 5G communication are applied will be described.

As in steps S1 and S3 of FIG. 3, the autonomous vehicle performs an initial access procedure and a random access procedure with the 5G network prior to step S1 of FIG. 3 in order to transmit/receive signals, information and the like to/from the 5G network.

More specifically, the autonomous vehicle performs an initial access procedure with the 5G network on the basis of an SSB in order to acquire DL synchronization and system information. A beam management (BM) procedure and a beam failure recovery procedure may be added in the initial access procedure, and quasi-co-location (QCL) relation may be added in a process in which the autonomous vehicle receives a signal from the 5G network.

In addition, the autonomous vehicle performs a random access procedure with the 5G network for UL synchronization acquisition and/or UL transmission. The 5G network can transmit, to the autonomous vehicle, a UL grant for scheduling transmission of specific information. Accordingly, the autonomous vehicle transmits the specific information to the 5G network on the basis of the UL grant. In addition, the 5G network transmits, to the autonomous vehicle, a DL grant for scheduling transmission of 5G processing results with respect to the specific information. Accordingly, the 5G network can transmit, to the autonomous vehicle, information (or a signal) related to remote control on the basis of the DL grant.

Next, a basic procedure of an applied operation to which a method proposed by the present disclosure which will be described later and URLLC of 5G communication are applied will be described.

As described above, an autonomous vehicle can receive DownlinkPreemption IE from the 5G network after the autonomous vehicle performs an initial access procedure and/or a random access procedure with the 5G network. Then, the autonomous vehicle receives DCI format 2_1 including a preemption indication from the 5G network on the basis of DownlinkPreemption IE. The autonomous vehicle does not perform (or expect or assume) reception of eMBB data in resources (PRBs and/or OFDM symbols) indicated by the preemption indication. Thereafter, when the autonomous vehicle needs to transmit specific information, the autonomous vehicle can receive a UL grant from the 5G network.

Next, a basic procedure of an applied operation to which a method proposed by the present disclosure which will be described later and mMTC of 5G communication are applied will be described.

Description will focus on parts in the steps of FIG. 3 which are changed according to application of mMTC.

In step S1 of FIG. 3, the autonomous vehicle receives a UL grant from the 5G network in order to transmit specific information to the 5G network. Here, the UL grant may include information on the number of repetitions of transmission of the specific information and the specific information may be repeatedly transmitted on the basis of the information on the number of repetitions. That is, the autonomous vehicle transmits the specific information to the 5G network on the basis of the UL grant. Repetitive transmission of the specific information may be performed through frequency hopping, the first transmission of the specific information may be performed in a first frequency resource, and the second transmission of the specific information may be performed in a second frequency resource. The specific information can be transmitted through a narrowband of 6 resource blocks (RBs) or 1 RB.

H. Autonomous Driving Operation Between Vehicles Using 5G Communication

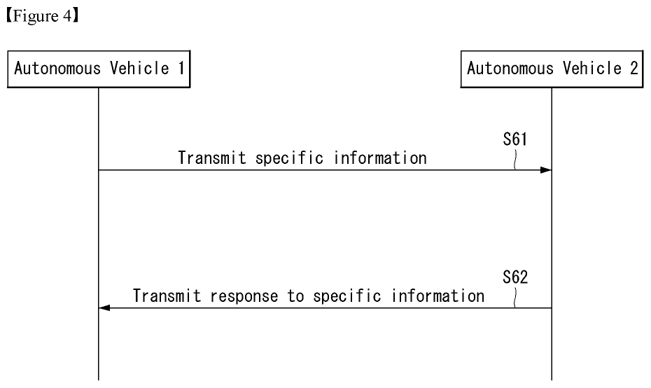

FIG. 4 shows an example of a basic operation between vehicles using 5G communication.

A first vehicle transmits specific information to a second vehicle (S61). The second vehicle transmits a response to the specific information to the first vehicle (S62).

Meanwhile, a configuration of an applied operation between vehicles may depend on whether the 5G network is directly (sidelink communication transmission mode 3) or indirectly (sidelink communication transmission mode 4) involved in resource allocation for the specific information and the response to the specific information.

Next, an applied operation between vehicles using 5G communication will be described.

First, a method in which a 5G network is directly involved in resource allocation for signal transmission/reception between vehicles will be described.

The 5G network can transmit DCI format 5A to the first vehicle for scheduling of mode-3 transmission (PSCCH and/or PSSCH transmission). Here, a physical sidelink control channel (PSCCH) is a 5G physical channel for scheduling of transmission of specific information a physical sidelink shared channel (PSSCH) is a 5G physical channel for transmission of specific information. In addition, the first vehicle transmits SCI format 1 for scheduling of specific information transmission to the second vehicle over a PSCCH. Then, the first vehicle transmits the specific information to the second vehicle over a PSSCH.

Next, a method in which a 5G network is indirectly involved in resource allocation for signal transmission/reception will be described.

The first vehicle senses resources for mode-4 transmission in a first window. Then, the first vehicle selects resources for mode-4 transmission in a second window on the basis of the sensing result. Here, the first window refers to a sensing window and the second window refers to a selection window. The first vehicle transmits SCI format 1 for scheduling of transmission of specific information to the second vehicle over a PSCCH on the basis of the selected resources. Then, the first vehicle transmits the specific information to the second vehicle over a PSSCH.

The above-described 5G communication technology can be combined with methods proposed in the present disclosure which will be described later and applied or can complement the methods proposed in the present disclosure to make technical features of the methods concrete and clear.

Driving

(1) Exterior of Vehicle

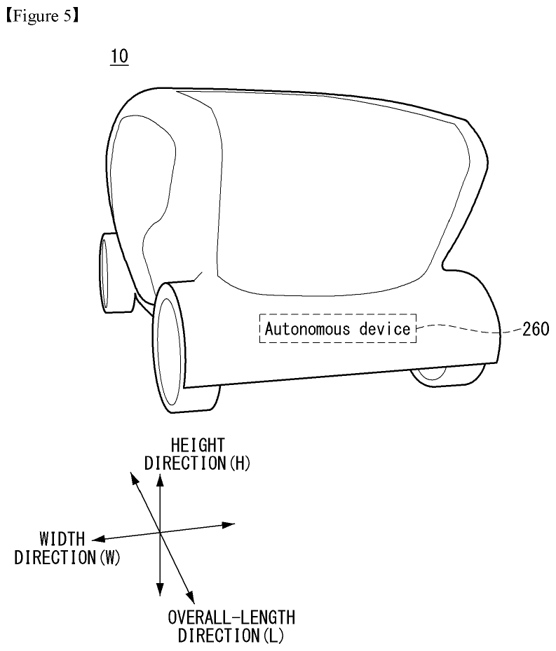

FIG. 5 is a diagram showing a vehicle according to an embodiment of the present disclosure.

Referring to FIG. 5, a vehicle 10 according to an embodiment of the present disclosure is defined as a transportation means traveling on roads or railroads. The vehicle 10 includes a car, a train and a motorcycle. The vehicle 10 may include an internal-combustion engine vehicle having an engine as a power source, a hybrid vehicle having an engine and a motor as a power source, and an electric vehicle having an electric motor as a power source. The vehicle 10 may be a private own vehicle. The vehicle 10 may be a shared vehicle. The vehicle 10 may be an autonomous vehicle.

(2) Components of Vehicle

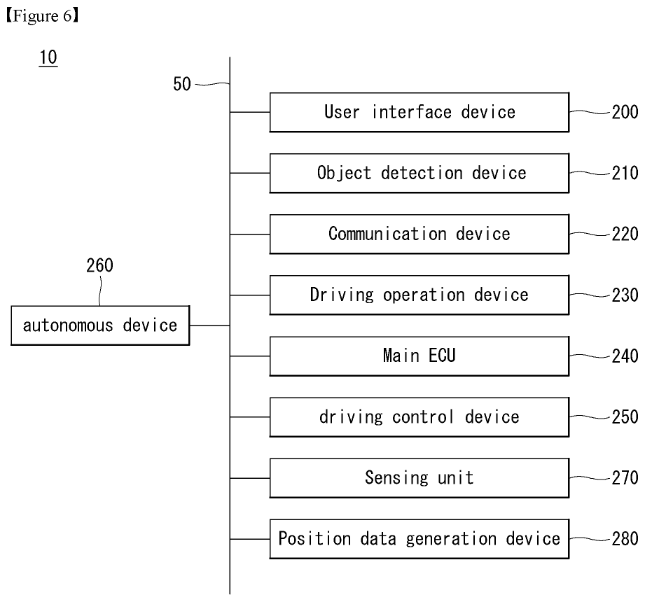

FIG. 6 is a control block diagram of the vehicle according to an embodiment of the present disclosure.

Referring to FIG. 6, the vehicle 10 may include a user interface device 200, an object detection device 210, a communication device 220, a driving operation device 230, a main ECU 240, a driving control device 250, an autonomous device 260, a sensing unit 270, and a position data generation device 280. The object detection device 210, the communication device 220, the driving operation device 230, the main ECU 240, the driving control device 250, the autonomous device 260, the sensing unit 270 and the position data generation device 280 may be realized by electronic devices which generate electric signals and exchange the electric signals from one another.

1) User Interface Device

The user interface device 200 is a device for communication between the vehicle 10 and a user. The user interface device 200 can receive user input and provide information generated in the vehicle 10 to the user. The vehicle 10 can realize a user interface (UI) or user experience (UX) through the user interface device 200. The user interface device 200 may include an input device, an output device and a user monitoring device.

2) Object Detection Device

The object detection device 210 can generate information about objects outside the vehicle 10. Information about an object can include at least one of information on presence or absence of the object, positional information of the object, information on a distance between the vehicle 10 and the object, and information on a relative speed of the vehicle 10 with respect to the object. The object detection device 210 can detect objects outside the vehicle 10. The object detection device 210 may include at least one sensor which can detect objects outside the vehicle 10. The object detection device 210 may include at least one of a camera, a radar, a lidar, an ultrasonic sensor and an infrared sensor. The object detection device 210 can provide data about an object generated on the basis of a sensing signal generated from a sensor to at least one electronic device included in the vehicle.

2.1) Camera

The camera can generate information about objects outside the vehicle 10 using images. The camera may include at least one lens, at least one image sensor, and at least one processor which is electrically connected to the image sensor, processes received signals and generates data about objects on the basis of the processed signals.

The camera may be at least one of a mono camera, a stereo camera and an around view monitoring (AVM) camera. The camera can acquire positional information of objects, information on distances to objects, or information on relative speeds with respect to objects using various image processing algorithms. For example, the camera can acquire information on a distance to an object and information on a relative speed with respect to the object from an acquired image on the basis of change in the size of the object over time. For example, the camera may acquire information on a distance to an object and information on a relative speed with respect to the object through a pin-hole model, road profiling, or the like. For example, the camera may acquire information on a distance to an object and information on a relative speed with respect to the object from a stereo image acquired from a stereo camera on the basis of disparity information.

The camera may be attached at a portion of the vehicle at which FOV (field of view) can be secured in order to photograph the outside of the vehicle. The camera may be disposed in proximity to the front windshield inside the vehicle in order to acquire front view images of the vehicle. The camera may be disposed near a front bumper or a radiator grill. The camera may be disposed in proximity to a rear glass inside the vehicle in order to acquire rear view images of the vehicle.

The camera may be disposed near a rear bumper, a trunk or a tail gate. The camera may be disposed in proximity to at least one of side windows inside the vehicle in order to acquire side view images of the vehicle. Alternatively, the camera may be disposed near a side mirror, a fender or a door.

2.2) Radar

The radar can generate information about an object outside the vehicle using electromagnetic waves. The radar may include an electromagnetic wave transmitter, an electromagnetic wave receiver, and at least one processor which is electrically connected to the electromagnetic wave transmitter and the electromagnetic wave receiver, processes received signals and generates data about an object on the basis of the processed signals. The radar may be realized as a pulse radar or a continuous wave radar in terms of electromagnetic wave emission. The continuous wave radar may be realized as a frequency modulated continuous wave (FMCW) radar or a frequency shift keying (FSK) radar according to signal waveform. The radar can detect an object through electromagnetic waves on the basis of TOF (Time of Flight) or phase shift and detect the position of the detected object, a distance to the detected object and a relative speed with respect to the detected object. The radar may be disposed at an appropriate position outside the vehicle in order to detect objects positioned in front of, behind or on the side of the vehicle.

2.3) Lidar

The lidar can generate information about an object outside the vehicle 10 using a laser beam. The lidar may include a light transmitter, a light receiver, and at least one processor which is electrically connected to the light transmitter and the light receiver, processes received signals and generates data about an object on the basis of the processed signal. The lidar may be realized according to TOF or phase shift. The lidar may be realized as a driven type or a non-driven type. A driven type lidar may be rotated by a motor and detect an object around the vehicle 10. A non-driven type lidar may detect an object positioned within a predetermined range from the vehicle according to light steering. The vehicle 10 may include a plurality of non-drive type lidars. The lidar can detect an object through a laser beam on the basis of TOF (Time of Flight) or phase shift and detect the position of the detected object, a distance to the detected object and a relative speed with respect to the detected object. The lidar may be disposed at an appropriate position outside the vehicle in order to detect objects positioned in front of, behind or on the side of the vehicle.

3) Communication Device

The communication device 220 can exchange signals with devices disposed outside the vehicle 10. The communication device 220 can exchange signals with at least one of infrastructure (e.g., a server and a broadcast station), another vehicle and a terminal. The communication device 220 may include a transmission antenna, a reception antenna, and at least one of a radio frequency (RF) circuit and an RF element which can implement various communication protocols in order to perform communication.

For example, the communication device can exchange signals with external devices on the basis of C-V2X (Cellular V2X). For example, C-V2X can include sidelink communication based on LTE and/or sidelink communication based on NR. Details related to C-V2X will be described later.

For example, the communication device can exchange signals with external devices on the basis of DSRC (Dedicated Short Range Communications) or WAVE

(Wireless Access in Vehicular Environment) standards based on IEEE 802.11p PHY/MAC layer technology and IEEE 1609 Network/Transport layer technology. DSRC (or WAVE standards) is communication specifications for providing an intelligent transport system (ITS) service through short-range dedicated communication between vehicle-mounted devices or between a roadside device and a vehicle-mounted device. DSRC may be a communication scheme that can use a frequency of 5.9 GHz and have a data transfer rate in the range of 3 Mbps to 27 Mbps. IEEE 802.11p may be combined with IEEE 1609 to support DSRC (or WAVE standards).

The communication device of the present disclosure can exchange signals with external devices using only one of C-V2X and DSRC. Alternatively, the communication device of the present disclosure can exchange signals with external devices using a hybrid of C-V2X and DSRC.

4) Driving Operation Device

The driving operation device 230 is a device for receiving user input for driving. In a manual mode, the vehicle 10 may be driven on the basis of a signal provided by the driving operation device 230. The driving operation device 230 may include a steering input device (e.g., a steering wheel), an acceleration input device (e.g., an acceleration pedal) and a brake input device (e.g., a brake pedal).

5) Main ECU

The main ECU 240 can control the overall operation of at least one electronic device included in the vehicle 10.

6) Driving Control Device

The driving control device 250 is a device for electrically controlling various vehicle driving devices included in the vehicle 10. The driving control device 250 may include a power train driving control device, a chassis driving control device, a door/window driving control device, a safety device driving control device, a lamp driving control device, and an air-conditioner driving control device. The power train driving control device may include a power source driving control device and a transmission driving control device. The chassis driving control device may include a steering driving control device, a brake driving control device and a suspension driving control device. Meanwhile, the safety device driving control device may include a seat belt driving control device for seat belt control.

The driving control device 250 includes at least one electronic control device (e.g., a control ECU (Electronic Control Unit)).

The driving control device 250 can control vehicle driving devices on the basis of signals received by the autonomous device 260. For example, the driving control device 250 can control a power train, a steering device and a brake device on the basis of signals received by the autonomous device 260.

7) Autonomous Device

The autonomous device 260 can generate a route for self-driving on the basis of acquired data. The autonomous device 260 can generate a driving plan for traveling along the generated route. The autonomous device 260 can generate a signal for controlling movement of the vehicle according to the driving plan. The autonomous device 260 can provide the signal to the driving control device 250.

The autonomous device 260 can implement at least one ADAS (Advanced Driver Assistance System) function. The ADAS can implement at least one of ACC (Adaptive Cruise Control), AEB (Autonomous Emergency Braking), FCW (Forward Collision Warning), LKA (Lane Keeping Assist), LCA (Lane Change Assist), TFA (Target Following Assist), BSD (Blind Spot Detection), HBA (High Beam Assist), APS (Auto Parking System), a PD collision warning system, TSR (Traffic Sign Recognition), TSA (Traffic Sign Assist), NV (Night Vision), DSM (Driver Status Monitoring) and TJA (Traffic Jam Assist).

The autonomous device 260 can perform switching from a self-driving mode to a manual driving mode or switching from the manual driving mode to the self-driving mode. For example, the autonomous device 260 can switch the mode of the vehicle 10 from the self-driving mode to the manual driving mode or from the manual driving mode to the self-driving mode on the basis of a signal received from the user interface device 200.

8) Sensing Unit

The sensing unit 270 can detect a state of the vehicle. The sensing unit 270 may include at least one of an internal measurement unit (IMU) sensor, a collision sensor, a wheel sensor, a speed sensor, an inclination sensor, a weight sensor, a heading sensor, a position module, a vehicle forward/backward movement sensor, a battery sensor, a fuel sensor, a tire sensor, a steering sensor, a temperature sensor, a humidity sensor, an ultrasonic sensor, an illumination sensor, and a pedal position sensor. Further, the IMU sensor may include one or more of an acceleration sensor, a gyro sensor and a magnetic sensor.

The sensing unit 270 can generate vehicle state data on the basis of a signal generated from at least one sensor. Vehicle state data may be information generated on the basis of data detected by various sensors included in the vehicle. The sensing unit 270 may generate vehicle attitude data, vehicle motion data, vehicle yaw data, vehicle roll data, vehicle pitch data, vehicle collision data, vehicle orientation data, vehicle angle data, vehicle speed data, vehicle acceleration data, vehicle tilt data, vehicle forward/backward movement data, vehicle weight data, battery data, fuel data, tire pressure data, vehicle internal temperature data, vehicle internal humidity data, steering wheel rotation angle data, vehicle external illumination data, data of a pressure applied to an acceleration pedal, data of a pressure applied to a brake panel, etc.

9) Position Data Generation Device

The position data generation device 280 can generate position data of the vehicle 10. The position data generation device 280 may include at least one of a global positioning system (GPS) and a differential global positioning system (DGPS). The position data generation device 280 can generate position data of the vehicle 10 on the basis of a signal generated from at least one of the GPS and the DGPS. According to an embodiment, the position data generation device 280 can correct position data on the basis of at least one of the inertial measurement unit (IMU) sensor of the sensing unit 270 and the camera of the object detection device 210. The position data generation device 280 may also be called a global navigation satellite system (GNSS).

The vehicle 10 may include an internal communication system 50. The plurality of electronic devices included in the vehicle 10 can exchange signals through the internal communication system 50. The signals may include data. The internal communication system 50 can use at least one communication protocol (e.g., CAN, LIN, FlexRay, MOST or Ethernet).

(3) Components of Autonomous Device

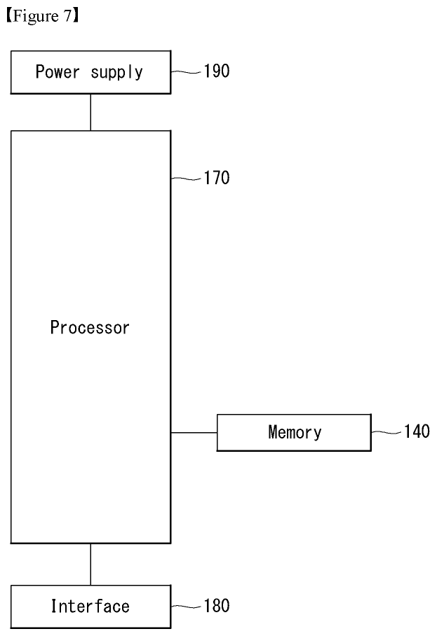

FIG. 7 is a control block diagram of the autonomous device according to an embodiment of the present disclosure.

Referring to FIG. 7, the autonomous device 260 may include a memory 140, a processor 170, an interface 180 and a power supply 190.

The memory 140 is electrically connected to the processor 170. The memory 140 can store basic data with respect to units, control data for operation control of units, and input/output data. The memory 140 can store data processed in the processor 170. Hardware-wise, the memory 140 can be configured as at least one of a ROM, a RAM, an EPROM, a flash drive and a hard drive. The memory 140 can store various types of data for overall operation of the autonomous device 260, such as a program for processing or control of the processor 170. The memory 140 may be integrated with the processor 170. According to an embodiment, the memory 140 may be categorized as a subcomponent of the processor 170.

The interface 180 can exchange signals with at least one electronic device included in the vehicle 10 in a wired or wireless manner. The interface 180 can exchange signals with at least one of the object detection device 210, the communication device 220, the driving operation device 230, the main ECU 240, the driving control device 250, the sensing unit 270 and the position data generation device 280 in a wired or wireless manner. The interface 180 can be configured using at least one of a communication module, a terminal, a pin, a cable, a port, a circuit, an element and a device.

The power supply 190 can provide power to the autonomous device 260. The power supply 190 can be provided with power from a power source (e.g., a battery) included in the vehicle 10 and supply the power to each unit of the autonomous device 260. The power supply 190 can operate according to a control signal supplied from the main ECU 240. The power supply 190 may include a switched-mode power supply (SMPS).

The processor 170 can be electrically connected to the memory 140, the interface 180 and the power supply 190 and exchange signals with these components. The processor 170 can be realized using at least one of application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, and electronic units for executing other functions.

The processor 170 can be operated by power supplied from the power supply 190. The processor 170 can receive data, process the data, generate a signal and provide the signal while power is supplied thereto.

The processor 170 can receive information from other electronic devices included in the vehicle 10 through the interface 180. The processor 170 can provide control signals to other electronic devices in the vehicle 10 through the interface 180.

The autonomous device 260 may include at least one printed circuit board (PCB). The memory 140, the interface 180, the power supply 190 and the processor 170 may be electrically connected to the PCB.

(4) Operation of Autonomous Device

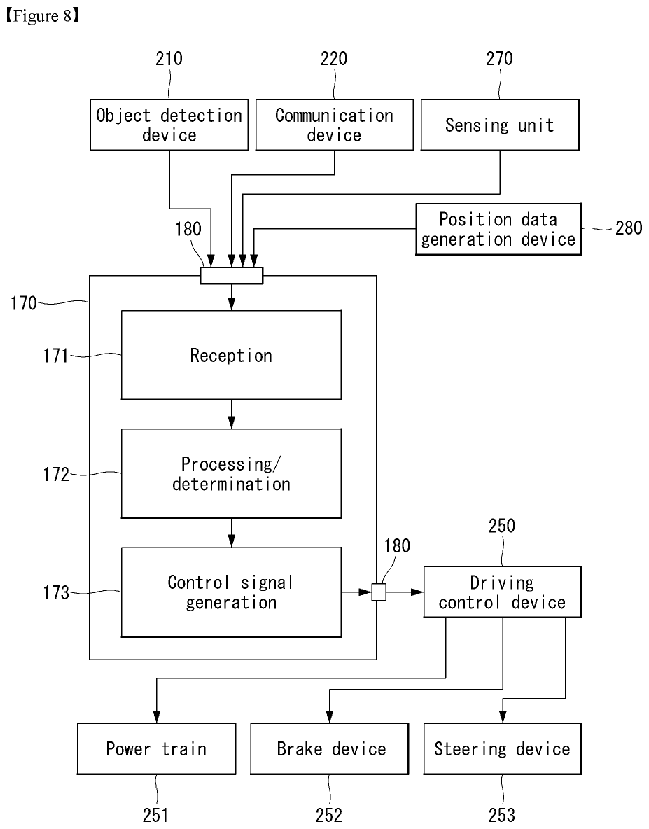

FIG. 8 is a diagram showing a signal flow in an autonomous vehicle according to an embodiment of the present disclosure.

1) Reception Operation

Referring to FIG. 8, the processor 170 can perform a reception operation. The processor 170 can receive data from at least one of the object detection device 210, the communication device 220, the sensing unit 270 and the position data generation device 280 through the interface 180. The processor 170 can receive object data from the object detection device 210. The processor 170 can receive HD map data from the communication device 220. The processor 170 can receive vehicle state data from the sensing unit 270. The processor 170 can receive position data from the position data generation device 280.

2) Processing/Determination Operation

The processor 170 can perform a processing/determination operation. The processor 170 can perform the processing/determination operation on the basis of traveling situation information. The processor 170 can perform the processing/determination operation on the basis of at least one of object data, HD map data, vehicle state data and position data.

2.1) Driving Plan Data Generation Operation

The processor 170 can generate driving plan data. For example, the processor 170 may generate electronic horizon data. The electronic horizon data can be understood as driving plan data in a range from a position at which the vehicle 10 is located to a horizon. The horizon can be understood as a point a predetermined distance before the position at which the vehicle 10 is located on the basis of a predetermined traveling route. The horizon may refer to a point at which the vehicle can arrive after a predetermined time from the position at which the vehicle 10 is located along a predetermined traveling route.

The electronic horizon data can include horizon map data and horizon path data.

2.1.1) Horizon Map Data

The horizon map data may include at least one of topology data, road data, HD map data and dynamic data. According to an embodiment, the horizon map data may include a plurality of layers. For example, the horizon map data may include a first layer that matches the topology data, a second layer that matches the road data, a third layer that matches the HD map data, and a fourth layer that matches the dynamic data. The horizon map data may further include static object data.

The topology data may be explained as a map created by connecting road centers. The topology data is suitable for approximate display of a location of a vehicle and may have a data form used for navigation for drivers. The topology data may be understood as data about road information other than information on driveways. The topology data may be generated on the basis of data received from an external server through the communication device 220. The topology data may be based on data stored in at least one memory included in the vehicle 10.

The road data may include at least one of road slope data, road curvature data and road speed limit data. The road data may further include no-passing zone data. The road data may be based on data received from an external server through the communication device 220. The road data may be based on data generated in the object detection device 210.

The HD map data may include detailed topology information in units of lanes of roads, connection information of each lane, and feature information for vehicle localization (e.g., traffic signs, lane marking/attribute, road furniture, etc.). The HD map data may be based on data received from an external server through the communication device 220.

The dynamic data may include various types of dynamic information which can be generated on roads. For example, the dynamic data may include construction information, variable speed road information, road condition information, traffic information, moving object information, etc. The dynamic data may be based on data received from an external server through the communication device 220. The dynamic data may be based on data generated in the object detection device 210.

The processor 170 can provide map data in a range from a position at which the vehicle 10 is located to the horizon.

2.1.2) Horizon Path Data

The horizon path data may be explained as a trajectory through which the vehicle 10 can travel in a range from a position at which the vehicle 10 is located to the horizon. The horizon path data may include data indicating a relative probability of selecting a road at a decision point (e.g., a fork, a junction, a crossroad, or the like). The relative probability may be calculated on the basis of a time taken to arrive at a final destination. For example, if a time taken to arrive at a final destination is shorter when a first road is selected at a decision point than that when a second road is selected, a probability of selecting the first road can be calculated to be higher than a probability of selecting the second road.

The horizon path data can include a main path and a sub-path. The main path may be understood as a trajectory obtained by connecting roads having a high relative probability of being selected. The sub-path can be branched from at least one decision point on the main path. The sub-path may be understood as a trajectory obtained by connecting at least one road having a low relative probability of being selected at at least one decision point on the main path.

3) Control Signal Generation Operation

The processor 170 can perform a control signal generation operation. The processor 170 can generate a control signal on the basis of the electronic horizon data. For example, the processor 170 may generate at least one of a power train control signal, a brake device control signal and a steering device control signal on the basis of the electronic horizon data.

The processor 170 can transmit the generated control signal to the driving control device 250 through the interface 180. The driving control device 250 can transmit the control signal to at least one of a power train 251, a brake device 252 and a steering device 254.

Cabin

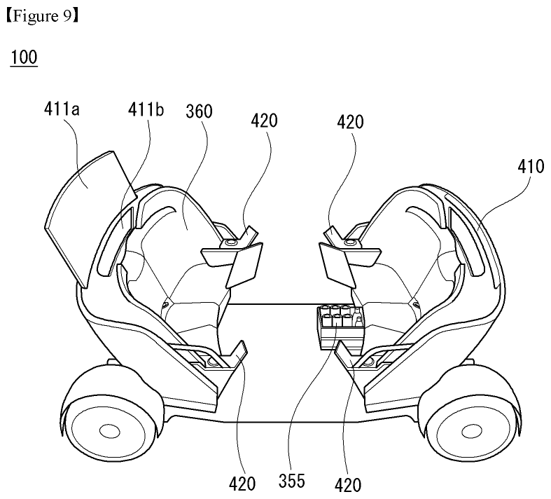

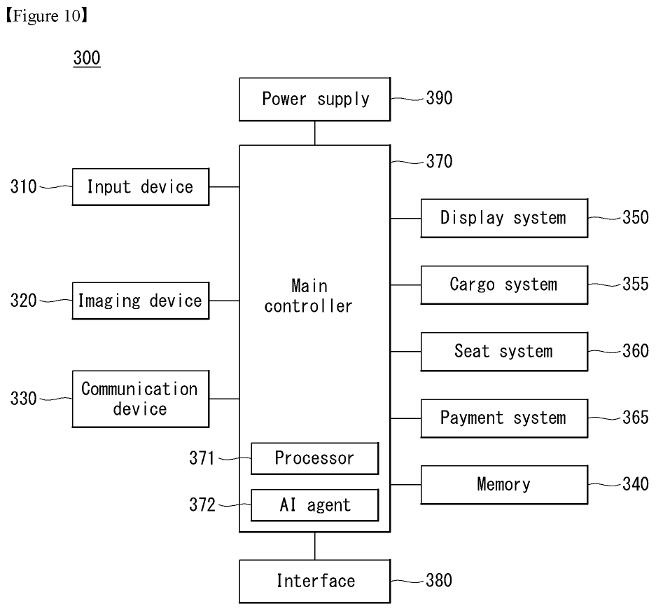

FIG. 9 is a diagram showing the interior of the vehicle according to an embodiment of the present disclosure. FIG. 10 is a block diagram referred to in description of a cabin system for a vehicle according to an embodiment of the present disclosure.

(1) Components of Cabin

Referring to FIGS. 9 and 10, a cabin system 300 for a vehicle (hereinafter, a cabin system) can be defined as a convenience system for a user who uses the vehicle 10. The cabin system 300 can be explained as a high-end system including a display system 350, a cargo system 355, a seat system 360 and a payment system 365. The cabin system 300 may include a main controller 370, a memory 340, an interface 380, a power supply 390, an input device 310, an imaging device 320, a communication device 330, the display system 350, the cargo system 355, the seat system 360 and the payment system 365. The cabin system 300 may further include components in addition to the components described in this specification or may not include some of the components described in this specification according to embodiments.

1) Main Controller

The main controller 370 can be electrically connected to the input device 310, the communication device 330, the display system 350, the cargo system 355, the seat system 360 and the payment system 365 and exchange signals with these components. The main controller 370 can control the input device 310, the communication device 330, the display system 350, the cargo system 355, the seat system 360 and the payment system 365. The main controller 370 may be realized using at least one of application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, and electronic units for executing other functions.

The main controller 370 may be configured as at least one sub-controller. The main controller 370 may include a plurality of sub-controllers according to an embodiment. The plurality of sub-controllers may individually control the devices and systems included in the cabin system 300. The devices and systems included in the cabin system 300 may be grouped by function or grouped on the basis of seats on which a user can sit.

The main controller 370 may include at least one processor 371. Although FIG. 6 illustrates the main controller 370 including a single processor 371, the main controller 371 may include a plurality of processors. The processor 371 may be categorized as one of the above-described sub-controllers.

The processor 371 can receive signals, information or data from a user terminal through the communication device 330. The user terminal can transmit signals, information or data to the cabin system 300.

The processor 371 can identify a user on the basis of image data received from at least one of an internal camera and an external camera included in the imaging device. The processor 371 can identify a user by applying an image processing algorithm to the image data. For example, the processor 371 may identify a user by comparing information received from the user terminal with the image data. For example, the information may include at least one of route information, body information, fellow passenger information, baggage information, position information, preferred content information, preferred food information, disability information and use history information of a user.

The main controller 370 may include an artificial intelligence (AI) agent 372. The AI agent 372 can perform machine learning on the basis of data acquired through the input device 310. The AI agent 371 can control at least one of the display system 350, the cargo system 355, the seat system 360 and the payment system 365 on the basis of machine learning results.

2) Essential Components

The memory 340 is electrically connected to the main controller 370. The memory 340 can store basic data about units, control data for operation control of units, and input/output data. The memory 340 can store data processed in the main controller 370. Hardware-wise, the memory 340 may be configured using at least one of a ROM, a RAM, an EPROM, a flash drive and a hard drive. The memory 340 can store various types of data for the overall operation of the cabin system 300, such as a program for processing or control of the main controller 370. The memory 340 may be integrated with the main controller 370.

The interface 380 can exchange signals with at least one electronic device included in the vehicle 10 in a wired or wireless manner. The interface 380 may be configured using at least one of a communication module, a terminal, a pin, a cable, a port, a circuit, an element and a device.

The power supply 390 can provide power to the cabin system 300. The power supply 390 can be provided with power from a power source (e.g., a battery) included in the vehicle 10 and supply the power to each unit of the cabin system 300. The power supply 390 can operate according to a control signal supplied from the main controller 370. For example, the power supply 390 may be implemented as a switched-mode power supply (SMPS).

The cabin system 300 may include at least one printed circuit board (PCB). The main controller 370, the memory 340, the interface 380 and the power supply 390 may be mounted on at least one PCB.

3) Input Device

The input device 310 can receive a user input. The input device 310 can convert the user input into an electrical signal. The electrical signal converted by the input device 310 can be converted into a control signal and provided to at least one of the display system 350, the cargo system 355, the seat system 360 and the payment system 365. The main controller 370 or at least one processor included in the cabin system 300 can generate a control signal based on an electrical signal received from the input device 310.

The input device 310 may include at least one of a touch input unit, a gesture input unit, a mechanical input unit and a voice input unit. The touch input unit can convert a user's touch input into an electrical signal. The touch input unit may include at least one touch sensor for detecting a user's touch input. According to an embodiment, the touch input unit can realize a touch screen by integrating with at least one display included in the display system 350. Such a touch screen can provide both an input interface and an output interface between the cabin system 300 and a user. The gesture input unit can convert a user's gesture input into an electrical signal. The gesture input unit may include at least one of an infrared sensor and an image sensor for detecting a user's gesture input. According to an embodiment, the gesture input unit can detect a user's three-dimensional gesture input. To this end, the gesture input unit may include a plurality of light output units for outputting infrared light or a plurality of image sensors. The gesture input unit may detect a user's three-dimensional gesture input using TOF (Time of Flight), structured light or disparity. The mechanical input unit can convert a user's physical input (e.g., press or rotation) through a mechanical device into an electrical signal. The mechanical input unit may include at least one of a button, a dome switch, a jog wheel and a jog switch. Meanwhile, the gesture input unit and the mechanical input unit may be integrated. For example, the input device 310 may include a jog dial device that includes a gesture sensor and is formed such that it can be inserted/ejected into/from a part of a surrounding structure (e.g., at least one of a seat, an armrest and a door). When the jog dial device is parallel to the surrounding structure, the jog dial device can serve as a gesture input unit. When the jog dial device is protruded from the surrounding structure, the jog dial device can serve as a mechanical input unit. The voice input unit can convert a user's voice input into an electrical signal. The voice input unit may include at least one microphone. The voice input unit may include a beam forming MIC.

4) Imaging Device

The imaging device 320 can include at least one camera. The imaging device 320 may include at least one of an internal camera and an external camera. The internal camera can capture an image of the inside of the cabin. The external camera can capture an image of the outside of the vehicle. The internal camera can acquire an image of the inside of the cabin. The imaging device 320 may include at least one internal camera. It is desirable that the imaging device 320 include as many cameras as the number of passengers who can ride in the vehicle. The imaging device 320 can provide an image acquired by the internal camera. The main controller 370 or at least one processor included in the cabin system 300 can detect a motion of a user on the basis of an image acquired by the internal camera, generate a signal on the basis of the detected motion and provide the signal to at least one of the display system 350, the cargo system 355, the seat system 360 and the payment system 365. The external camera can acquire an image of the outside of the vehicle. The imaging device 320 may include at least one external camera. It is desirable that the imaging device 320 include as many cameras as the number of doors through which passengers ride in the vehicle. The imaging device 320 can provide an image acquired by the external camera. The main controller 370 or at least one processor included in the cabin system 300 can acquire user information on the basis of the image acquired by the external camera. The main controller 370 or at least one processor included in the cabin system 300 can authenticate a user or acquire body information (e.g., height information, weight information, etc.), fellow passenger information and baggage information of a user on the basis of the user information.

5) Communication Device

The communication device 330 can exchange signals with external devices in a wireless manner. The communication device 330 can exchange signals with external devices through a network or directly exchange signals with external devices. External devices may include at least one of a server, a mobile terminal and another vehicle. The communication device 330 may exchange signals with at least one user terminal. The communication device 330 may include an antenna and at least one of an RF circuit and an RF element which can implement at least one communication protocol in order to perform communication. According to an embodiment, the communication device 330 may use a plurality of communication protocols. The communication device 330 may switch communication protocols according to a distance to a mobile terminal.

For example, the communication device can exchange signals with external devices on the basis of C-V2X (Cellular V2X). For example, C-V2X may include sidelink communication based on LTE and/or sidelink communication based on NR. Details related to C-V2X will be described later.

For example, the communication device can exchange signals with external devices on the basis of DSRC (Dedicated Short Range Communications) or WAVE (Wireless Access in Vehicular Environment) standards based on IEEE 802.11p PHY/MAC layer technology and IEEE 1609 Network/Transport layer technology. DSRC (or WAVE standards) is communication specifications for providing an intelligent transport system (ITS) service through short-range dedicated communication between vehicle-mounted devices or between a roadside device and a vehicle-mounted device. DSRC may be a communication scheme that can use a frequency of 5.9 GHz and have a data transfer rate in the range of 3 Mbps to 27 Mbps. IEEE 802.11p may be combined with IEEE 1609 to support DSRC (or WAVE standards).

The communication device of the present disclosure can exchange signals with external devices using only one of C-V2X and DSRC. Alternatively, the communication device of the present disclosure can exchange signals with external devices using a hybrid of C-V2X and DSRC.

6) Display System

The display system 350 can display graphic objects. The display system 350 may include at least one display device. For example, the display system 350 may include a first display device 410 for common use and a second display device 420 for individual use.

6.1) Common Display Device

The first display device 410 may include at least one display 411 which outputs visual content. The display 411 included in the first display device 410 may be realized by at least one of a flat panel display, a curved display, a rollable display and a flexible display. For example, the first display device 410 may include a first display 411 which is positioned behind a seat and formed to be inserted/ejected into/from the cabin, and a first mechanism for moving the first display 411. The first display 411 may be disposed such that it can be inserted/ejected into/from a slot formed in a seat main frame. According to an embodiment, the first display device 410 may further include a flexible area control mechanism. The first display may be formed to be flexible and a flexible area of the first display may be controlled according to user position. For example, the first display device 410 may be disposed on the ceiling inside the cabin and include a second display formed to be rollable and a second mechanism for rolling or unrolling the second display. The second display may be formed such that images can be displayed on both sides thereof. For example, the first display device 410 may be disposed on the ceiling inside the cabin and include a third display formed to be flexible and a third mechanism for bending or unbending the third display. According to an embodiment, the display system 350 may further include at least one processor which provides a control signal to at least one of the first display device 410 and the second display device 420. The processor included in the display system 350 can generate a control signal on the basis of a signal received from at last one of the main controller 370, the input device 310, the imaging device 320 and the communication device 330.

A display area of a display included in the first display device 410 may be divided into a first area 411a and a second area 411b. The first area 411a can be defined as a content display area. For example, the first area 411 may display at least one of graphic objects corresponding to can display entertainment content (e.g., movies, sports, shopping, food, etc.), video conferences, food menu and augmented reality screens. The first area 411a may display graphic objects corresponding to traveling situation information of the vehicle 10. The traveling situation information may include at least one of object information outside the vehicle, navigation information and vehicle state information. The object information outside the vehicle may include information on presence or absence of an object, positional information of an object, information on a distance between the vehicle and an object, and information on a relative speed of the vehicle with respect to an object. The navigation information may include at least one of map information, information on a set destination, route information according to setting of the destination, information on various objects on a route, lane information and information on the current position of the vehicle. The vehicle state information may include vehicle attitude information, vehicle speed information, vehicle tilt information, vehicle weight information, vehicle orientation information, vehicle battery information, vehicle fuel information, vehicle tire pressure information, vehicle steering information, vehicle indoor temperature information, vehicle indoor humidity information, pedal position information, vehicle engine temperature information, etc. The second area 411b can be defined as a user interface area. For example, the second area 411b may display an AI agent screen. The second area 411b may be located in an area defined by a seat frame according to an embodiment. In this case, a user can view content displayed in the second area 411b between seats. The first display device 410 may provide hologram content according to an embodiment. For example, the first display device 410 may provide hologram content for each of a plurality of users such that only a user who requests the content can view the content.

6.2) Display Device for Individual Use

The second display device 420 can include at least one display 421. The second display device 420 can provide the display 421 at a position at which only an individual passenger can view display content. For example, the display 421 may be disposed on an armrest of a seat. The second display device 420 can display graphic objects corresponding to personal information of a user. The second display device 420 may include as many displays 421 as the number of passengers who can ride in the vehicle. The second display device 420 can realize a touch screen by forming a layered structure along with a touch sensor or being integrated with the touch sensor. The second display device 420 can display graphic objects for receiving a user input for seat adjustment or indoor temperature adjustment.

7) Cargo System

The cargo system 355 can provide items to a user at the request of the user. The cargo system 355 can operate on the basis of an electrical signal generated by the input device 310 or the communication device 330. The cargo system 355 can include a cargo box. The cargo box can be hidden in a part under a seat. When an electrical signal based on user input is received, the cargo box can be exposed to the cabin. The user can select a necessary item from articles loaded in the cargo box. The cargo system 355 may include a sliding moving mechanism and an item pop-up mechanism in order to expose the cargo box according to user input. The cargo system 355 may include a plurality of cargo boxes in order to provide various types of items. A weight sensor for determining whether each item is provided may be embedded in the cargo box.

8) Seat System

The seat system 360 can provide a user customized seat to a user. The seat system 360 can operate on the basis of an electrical signal generated by the input device 310 or the communication device 330. The seat system 360 can adjust at least one element of a seat on the basis of acquired user body data. The seat system 360 may include a user detection sensor (e.g., a pressure sensor) for determining whether a user sits on a seat. The seat system 360 may include a plurality of seats on which a plurality of users can sit. One of the plurality of seats can be disposed to face at least another seat. At least two users can set facing each other inside the cabin.

9) Payment System

The payment system 365 can provide a payment service to a user. The payment system 365 can operate on the basis of an electrical signal generated by the input device 310 or the communication device 330. The payment system 365 can calculate a price for at least one service used by the user and request the user to pay the calculated price.

(2) Autonomous Vehicle Usage Scenarios

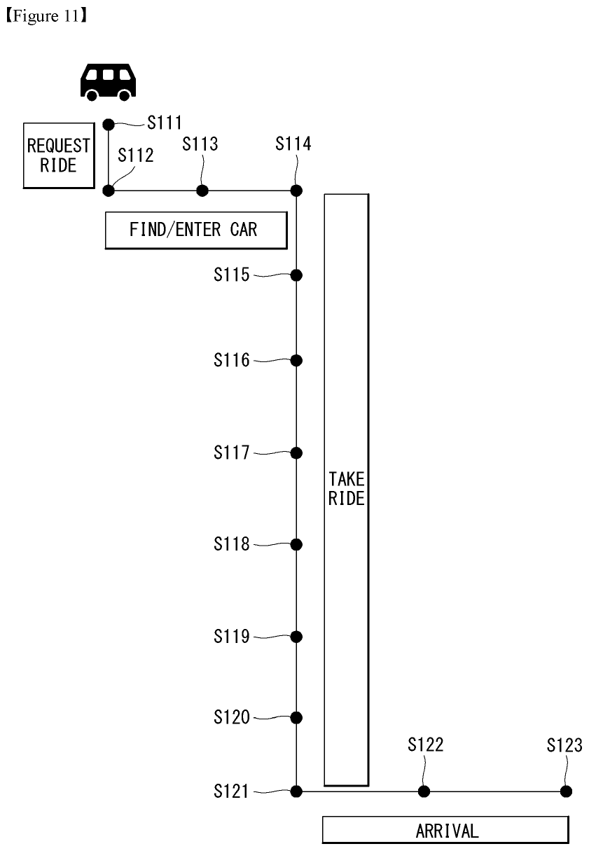

FIG. 11 is a diagram referred to in description of a usage scenario of a user according to an embodiment of the present disclosure.

1) Destination Prediction Scenario

A first scenario S111 is a scenario for prediction of a destination of a user. An application which can operate in connection with the cabin system 300 can be installed in a user terminal. The user terminal can predict a destination of a user on the basis of user's contextual information through the application. The user terminal can provide information on unoccupied seats in the cabin through the application.

2) Cabin Interior Layout Preparation Scenario

A second scenario S112 is a cabin interior layout preparation scenario. The cabin system 300 may further include a scanning device for acquiring data about a user located outside the vehicle. The scanning device can scan a user to acquire body data and baggage data of the user. The body data and baggage data of the user can be used to set a layout. The body data of the user can be used for user authentication. The scanning device may include at least one image sensor. The image sensor can acquire a user image using light of the visible band or infrared band.

The seat system 360 can set a cabin interior layout on the basis of at least one of the body data and baggage data of the user. For example, the seat system 360 may provide a baggage compartment or a car seat installation space.

3) User Welcome Scenario

A third scenario S113 is a user welcome scenario. The cabin system 300 may further include at least one guide light. The guide light can be disposed on the floor of the cabin. When a user riding in the vehicle is detected, the cabin system 300 can turn on the guide light such that the user sits on a predetermined seat among a plurality of seats. For example, the main controller 370 may realize a moving light by sequentially turning on a plurality of light sources over time from an open door to a predetermined user seat.

4) Seat Adjustment Service Scenario

A fourth scenario S114 is a seat adjustment service scenario. The seat system 360 can adjust at least one element of a seat that matches a user on the basis of acquired body information.

5) Personal Content Provision Scenario

A fifth scenario S115 is a personal content provision scenario. The display system 350 can receive user personal data through the input device 310 or the communication device 330. The display system 350 can provide content corresponding to the user personal data.

6) Item Provision Scenario

A sixth scenario S116 is an item provision scenario. The cargo system 355 can receive user data through the input device 310 or the communication device 330. The user data may include user preference data, user destination data, etc. The cargo system 355 can provide items on the basis of the user data.

7) Payment Scenario

A seventh scenario S117 is a payment scenario. The payment system 365 can receive data for price calculation from at least one of the input device 310, the communication device 330 and the cargo system 355. The payment system 365 can calculate a price for use of the vehicle by the user on the basis of the received data. The payment system 365 can request payment of the calculated price from the user (e.g., a mobile terminal of the user).

8) Display System Control Scenario of User

An eighth scenario S118 is a display system control scenario of a user. The input device 310 can receive a user input having at least one form and convert the user input into an electrical signal. The display system 350 can control displayed content on the basis of the electrical signal.

9) AI Agent Scenario

A ninth scenario S119 is a multi-channel artificial intelligence (AI) agent scenario for a plurality of users. The AI agent 372 can discriminate user inputs from a plurality of users. The AI agent 372 can control at least one of the display system 350, the cargo system 355, the seat system 360 and the payment system 365 on the basis of electrical signals obtained by converting user inputs from a plurality of users.

10) Multimedia Content Provision Scenario for Multiple Users

A tenth scenario S120 is a multimedia content provision scenario for a plurality of users. The display system 350 can provide content that can be viewed by all users together. In this case, the display system 350 can individually provide the same sound to a plurality of users through speakers provided for respective seats. The display system 350 can provide content that can be individually viewed by a plurality of users. In this case, the display system 350 can provide individual sound through a speaker provided for each seat.

11) User Safety Secure Scenario

An eleventh scenario S121 is a user safety secure scenario. When information on an object around the vehicle which threatens a user is acquired, the main controller 370 can control an alarm with respect to the object around the vehicle to be output through the display system 350.

12) Personal Belongings Loss Prevention Scenario

A twelfth scenario S122 is a user's belongings loss prevention scenario. The main controller 370 can acquire data about user's belongings through the input device 310. The main controller 370 can acquire user motion data through the input device 310. The main controller 370 can determine whether the user exits the vehicle leaving the belongings in the vehicle on the basis of the data about the belongings and the motion data. The main controller 370 can control an alarm with respect to the belongings to be output through the display system 350.

13) Alighting Report Scenario

A thirteenth scenario S123 is an alighting report scenario. The main controller 370 can receive alighting data of a user through the input device 310. After the user exits the vehicle, the main controller 370 can provide report data according to alighting to a mobile terminal of the user through the communication device 330. The report data can include data about a total charge for using the vehicle 10.

The above-describe 5G communication technology can be combined with methods proposed in the present disclosure which will be described later and applied or can complement the methods proposed in the present disclosure to make technical features of the present disclosure concrete and clear.

Hereinafter, various embodiments of the present disclosure will be described in detail with reference to the attached drawings.

The above-described present disclosure can be implemented with computer-readable code in a computer-readable medium in which program has been recorded. The computer-readable medium may include all kinds of recording devices capable of storing data readable by a computer system. Examples of the computer-readable medium may include a hard disk drive (HDD), a solid state disk (SSD), a silicon disk drive (SDD), a ROM, a RAM, a CD-ROM, magnetic tapes, floppy disks, optical data storage devices, and the like and also include such a carrier-wave type implementation (for example, transmission over the Internet). Therefore, the above embodiments are to be construed in all aspects as illustrative and not restrictive. The scope of the disclosure should be determined by the appended claims and their legal equivalents, not by the above description, and all changes coming within the meaning and equivalency range of the appended claims are intended to be embraced therein.

Furthermore, although the disclosure has been described with reference to the exemplary embodiments, those skilled in the art will appreciate that various modifications and variations can be made in the present disclosure without departing from the spirit or scope of the disclosure described in the appended claims. For example, each component described in detail in embodiments can be modified. In addition, differences related to such modifications and applications should be interpreted as being included in the scope of the present disclosure defined by the appended claims.

Although description has been made focusing on examples in which the present disclosure is applied to automated vehicle & highway systems based on 5G (5 generation) system, the present disclosure is also applicable to various wireless communication systems and autonomous devices.

In general, vehicle driving/riding in a limited space for a long time causes accumulation of fatigue of a driver and a passenger, leading to low vehicle use satisfaction and utilization rate in long-distance driving.

Meanwhile, even though fatigue during driving decreases with the popularization of autonomous vehicles, if a driver and a passenger concentrate on use of other services in a vehicle, the driver and the passenger (hereinafter, a driver) are not aware of appropriate rest time and thus fatigue is excessively accumulated.

Further, there may be various causes of fatigue of a passenger in a limited vehicle space, but the causes are not appropriately analyzed and thus the passenger takes a rest through a uniform method and fatigue is not solved.

Accordingly, to solve this problem, this specification proposes a method of monitoring a state of a passenger when a vehicle is used and providing appropriate rest information necessary for a driver by.

Further, this specification proposes a system for monitoring an action of a driver in a vehicle (monitoring utilization of service/posture change) and a driving state (driving route/driving pattern) of the vehicle to provide an appropriate rest time and/or method.

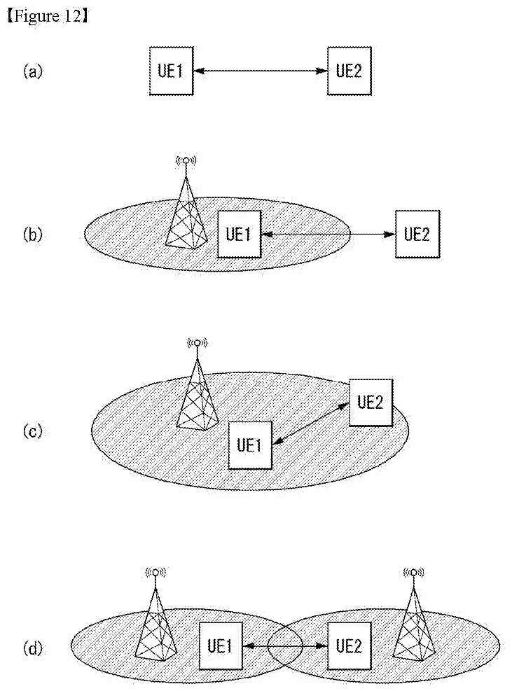

FIG. 12 shows an example of various scenarios of sidelink.

A scenario of sidelink may be largely classified into (1) an out-of-coverage network, (2) a partial-coverage network, and (3) an in-coverage network in accordance with whether UE1 and UE2 are positioned in or out of a coverage.

The in-coverage network may be classified into an in-coverage-single-cell and an in-coverage-multi-cell in accordance with the number of cells corresponding to the coverage of a BS. FIG. 12(a) shows an example of an out-of-coverage network of D2D communication. An out-of-coverage network scenario refers to performing sidelink between UEs without control of a BS.

It can be seen in FIG. 12(a) that only a UE1 and a UE2 exist and the UE1 and UE2 perform direct communication. FIG. 12(b) shows an example of the partial-coverage network of sidelink. A partial-coverage network scenario refers to performing sidelink between a UE positioned in a network coverage and a UE positioned outside the network coverage. It can be seen in FIG. 12(b) that a UE1 positioned in a network coverage and a UE2 positioned outside the network coverage communicate with each other. FIG. 12(c) shows an example of an in-coverage-single cell scenario and FIG. 12(d) shows an example of an in-coverage-multi-cell scenario. The in-coverage network scenario refers to that UEs perform sidelink in a network coverage through control of a BS. In FIG. 12(c), a UE1 and a UE2 are positioned in the same network coverage (or cell) and perform sidelink under control of a BS. In FIG. 12(d), a UE1 and a UE2 are positioned in a network coverage, but are positioned in different network coverages. Further, the UE1 and the UE2 perform sidelink under control of BSs that manage the network coverages, respectively.

Sidelink transmission may be operated in an uplink spectrum in FDD and may be operated in an uplink (or downlink) subframe in TDD. A TDM (Time Division Multiplexing) may be used for multiplexing sidelink transmission and uplink transmission. Depending on the ability of UEs, sidelink transmission and uplink transmission do not simultaneously occur in specific UEs. For example, sidelink transmission does not occur in a sidelink subframe partially or fully overlapping an uplink subframe that is used for uplink transmission. Further, sidelink transmission and downlink transmission also do not simultaneously occur. Further, transmission and reception of sidelink also do not simultaneously occur. As the architecture of physical resources that are used for sidelink transmission, the architecture of uplink physical resources may be used in the same way. However, the last symbol of a sidelink subframe is configured as a guard period, so it is not used for sidelink transmission. Sidelink may largely include sidelink discovery, sidelink communication, V2X sidelink communication, and sidelink synchronization.

The sidelink communication is a communication mode in which a UE can perform direct communication through a PC5 interface. This communication mode is supported when a UE is served by E-UTRAN and when a UE is positioned outside an E-UTRA coverage. In order to perform synchronization for an out-of-coverage operation, a UE(s) can operate as a synchronization source by transmitting a sidelink broadcast control channel (SBCCH) and a synchronization signal.

The SBCCH transmits the most important system information for receiving another sidelink channel and signal. The SBCCH is transmitted with a fixed cycle of 40 ms with a synchronization signal. When a UE is in a network coverage, the contents of the SBCCH are derived or acquired from parameters signaled by a BS.

When the UE is outside the coverage and selects another UE as a synchronization reference, the contents of the SBCCH are derived from the received SBCCH. Otherwise, the UE use pre-configured parameters.

For an out-of-coverage operation, two pre-configured subframes exist at ever 40 ms. The UE receives a synchronization signal and an SBCCH at one subframe, and when the UE becomes a synchronization source in accordance with a defined reference, the UE transmits a synchronization signal and an SBCCH at another subframe.

The UE performs sidelink communication on subframes defined over duration time of a sidelink control period. The sidelink control period is a period for which resources are allocated to a cell to transmit sidelink control information and sidelink data. Within the sidelink control period, the UE transmits sidelink control information and sidelink data.

The sidelink control information shows a layer 1 ID and transmission characteristics (e.g., MSC, and a position and timing alignment of resources for the sidelink control period).

Sidelink Radio Protocol Architecture

A UE radio protocol architecture for sidelink is described for a user plane and a control plane.

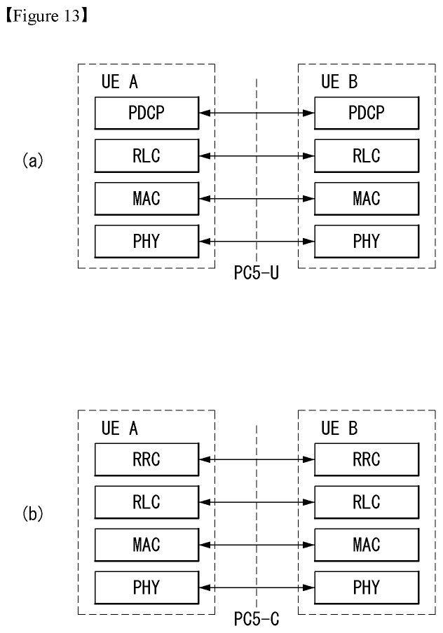

FIG. 13 shows a protocol stack for sidelink.

In detail, FIG. 13(a) shows a protocol stack for a user plane where PDCP, RLC, and MAC sublayers (ended in another UE) perform functions for a user plane.

An access layer protocol stack of a PC5 interface is, as in FIG. 13(a), composed of PDCP, RLC, MAC, and PHY.

FIG. 13(b) shows a control plane protocol stack for an SBCCH to which implementation(s) of the present disclosure can be applied. An access stratum (AS) protocol stack for an SBCCH in the PC5 interface, as in FIG. 13(b), is composed of an RRC, an RLC, a MAC, and a PHY.

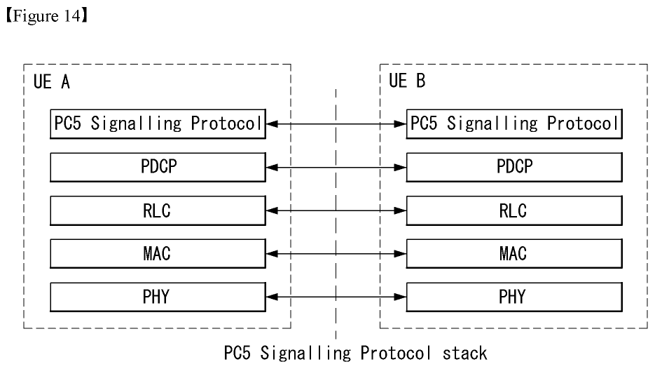

A control plane for setting, maintaining, and removing logical information for one-to-one sidelink communication is shown in FIG. 14. FIG. 14 shows a control plane protocol stack for one-to-one sidelink.

3GPP TS 23.303, 3GPP TS 23.285, and 3GPP TS 24.386 may be referred for more detailed description about the sidelink protocol stack.

Sidelink Discovery

Since several transmission/reception UEs are distributed at random positions in sidelink, before a specific UE performs sidelink communication with surrounding UEs, a sidelink discovery process that checks existence of surrounding UEs is required. Further, sidelink discovery may be used not only for checking existence of surrounding UEs, as described above, but also for various commercial purposes such as advertising to UEs in an adjacent region, issuing a coupon, and searching for friends.

The sidelink discovery may be applied within a network coverage. In this case, signals (or messages) that UEs periodically transmit for the sidelink discovery may be referred to as discovery massages, discovery signals, and beacons. Hereafter, for the convenience of description, signals that UEs periodically transmit for the sidelink discovery are generally referred to as discovery messages.

When a UE1 has a role of transmitting a discovery message, the UE1 transmits a discovery message and a UE2 receives the discovery message. The roles of transmission and reception of the UE1 and the UE2 may be exchanged. Transmission from the UE1 may be received by one or more UE(s) such as the UE2.

A discovery message may include a single MAC PDU, in which the single MAC PDU may include a UE identifier (ID) and an application identifier (ID).

A channel for transmitting a discovery message may be defined as a physical sidelink discovery channel (PSDCH). A PUSCH architecture may be reused as the architecture of the PSDCH channel.

Two types (a sidelink discovery type 1 and a sidelink discovery type 2B) may be used as a resource allocation method for the sidelink discovery.

As for the sidelink discovery type 1, a BS can allocate resources for discovery message transmission in a non-UE specific manner. In detail, a radio resource pool (i.e., a discovery pool) for discovery transmission and reception that is composed of a plurality of subframe sets and a plurality of resource block sets is allocated within a specific period (hereafter, ‘discovery period’), and a discovery transmission UE randomly selects a specific resource in the radio resource pool and then transmits a discovery message. This periodic discovery resource pool can be allocated for discovery signal transmission in a semi-static manner. Setting information of a discovery resource pool for discovery transmission includes a discovery period, and a subframe set information and a resource block set information that can be used for transmission of a discovery signal in the discovery period. This setting information of a discovery resource pool can be transmitted to a UE by RRC signaling. As for an in-coverage UE, a discovery resource pool for discovery transmission may be set by a BS and may be noticed to a UE using RRC signaling (e.g., an SIB (System Information Block)). A discovery resource pool allocated for discovery within one discover period can be multiplexed into time-frequency resource blocks having the same size through TDM and/or FDM, and such time-frequency resource blocks having the same size may be referred to as discovery resources. The discovery resource may be divided into one subframe unit and may include two resource blocks (RB) per slot in each subframe. One discovery resource may be used for transmission of a discovery MAC PDU by one UE. Further, the UE can repeatedly transmit discovery signals within a discovery period to transmit one transport block. Transmission of a MAC PDU by one UE can be repeated contiguously or non-contiguously within a discovery period (i.e., a radio resource pool). A transmission number of times of discovery signals for one transport block can be transmitted to a UE by upper hierarchy signaling. The UE can randomly select the first discovery resource from a discovery resource set that can be used for repeated transmission of the MAC PDU, and other discovery resources can be determined in relation to the first discovery resource. For example, a predetermined pattern may be set in advance and the next discovery resource may be determined in accordance with the predetermined pattern, depending on the position of the discovery resource that the UE has selected first. Further, the UE can randomly select each discovery resource in a discovery resource set that can be used for repeated transmission of the MAC PDU.

As for the sidelink discovery type 2, a resource for discovery message transmission is UE-specifically allocated. The type 2 is subdivided into a type 2A and a type 2B. The type 2A is a manner in which a UE allocates a resource at every transmission instance of a discovery message within a discovery period and the type 2B is a manner that allocates a resource in a semi-persistent manner. In the sidelink discovery type 2, a RRC_CONNECTED UE requests a resource for transmission of a side discovery message from a BS through RRC signaling.

Further, the BS can allocate a resource through RRC signaling. When a UE transits to an RRC_IDLE state or a BS withdraws resource allocation through RRC signaling, the UE removes the transmission resource that has been most recently allocated. As described above, in the sidelink discovery type 2B, a radio resource can be allocated by RRC signaling and activation/deactivation of a radio resource allocated by a PDCCH can be determined. A discovery resource pool for discovery message transmission may be set by a BS and may be noticed to a UE using RRC signaling (e.g., an SIB (System Information Block)).

A discover message reception UE monitors the discovery resource pools of both of the sidelink discovery types 1 and 2 described above for discovery message reception.

The sidelink discovery manner may be classified into a centralized discovery manner that is helped by a central node such as a BS and a distributed discovery manner in which a UE checks existence of surrounding UE by itself without help of a central node. In the distributed discovery manner, as a resource for a UE to transmit and receive a discovery message, a dedicated resource can be periodically allocated regardless of a cellular resource.

Sidelink Communication

An application region of sidelink communication includes not only the inside and outside a network coverage (in-coverage and out-of-coverage), but also a network coverage edge region (edge-of-coverage). The sidelink communication may be used for purposes such as PS (Public Safety).

When a UE1 has a role of directly transmitting communication data, the UE1 directly transmits communication data and a UE2 directly receives communication data. The roles of transmission and reception of the UE1 and the UE2 may be exchanged. Direction communication transmission from the UE1 may be received by one or more UE(s) such as the UE2.

The sidelink discovery and the sidelink communication can be independently defined without being linked with each other. That is, a sidelink discovery is not required in groupcast and broadcast direct communication. As described above, when the sidelink discovery and the sidelink communication can be independently defined, UEs do not need to recognize adjacent UEs. In other words, in groupcast and broadcast direct communication, it is not required that all reception UEs in a group are adjacent to each other.

A physical sidelink shared channel (PSSCH) may be defined as a channel that transmits sidelink communication data. Further, a physical sidelink control channel (PSCCH) may be defined as a channel that transmits control information for sidelink communication (e.g., scheduling assignment (SA), a transmission format, etc. for sidelink communication data transmission). The PSSCH and the PSCCH may reuse a PUSCH architecture.

As a resource allocation method for sidelink communication, two modes (Mode 1/Mode 3, Mode 2/Mode 4) may be used.

Here, the Mode 3/Mode 4 means a resource allocation method for V2X sidelink communication and this part is described in more detail than in V2X.

The Mode 3/Mode 4 refers to a manner that schedules resources that a BS uses to transmit data or control information for sidelink communication to a UE. Mode 1 is applied in in-coverage.

The BS sets a resource pool for sidelink communication. The BS can transmit information about the resource pool for sidelink communication to the UE through RRC signaling. The resource pool for sidelink communication can be classified into a control information pool (i.e., a resource pool for transmitting a PSCCH) and a sidelink data pool (i.e., a resource pool for transmitting a PSSCH).

When a transmission UE requests a resource for transmitting control information and/or data from the BS, the BS schedules a control information and sidelink data transmission resource in a set pool to a D2D UE using a physical downlink control channel. Accordingly, the transmission UE transmits the control information and the sidelink data to the reception UE using the scheduled (i.e., allocated) resource.

In detail, the BS can perform scheduling on a resource for transmitting control information (i.e., a resource for transmitting a PSCCH) using a DCI (Downlink Control Information) format 5 or a DCI format 5A and can perform scheduling on a resource for transmitting sidelink data (i.e., a resource for transmitting a PSSCH) using an SCI (Sidelink Control Information) format) or an SCI format 1. In this case, the DCI format 5 includes some fields of the SCI format 0 and the DCI format 5A includes some fields of the SCI format 1.

In the Mode 1/Mode 3, the transmission UE should be in a RRC_CONNECTED state to perform sidelink communication. The transmission UE transmits a scheduling request to the BS and then a BSR (Buffer Status Report) process that is a process of reporting the amount of uplink data that the UE will transmit is performed such that the BS can determine the amount of resources requested by the UE.

The reception UEs monitors the control information pool, and can selectively decode sidelink data transmission related to corresponding control information by decoding control information related to themselves, respectively. The reception UEs may not decode the sidelink data, depending on the result of decoding the control information.

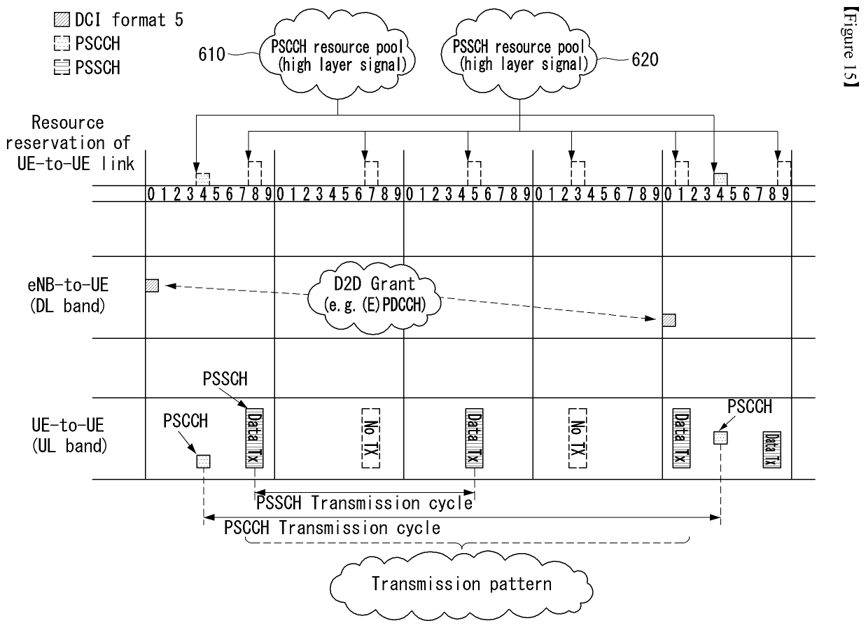

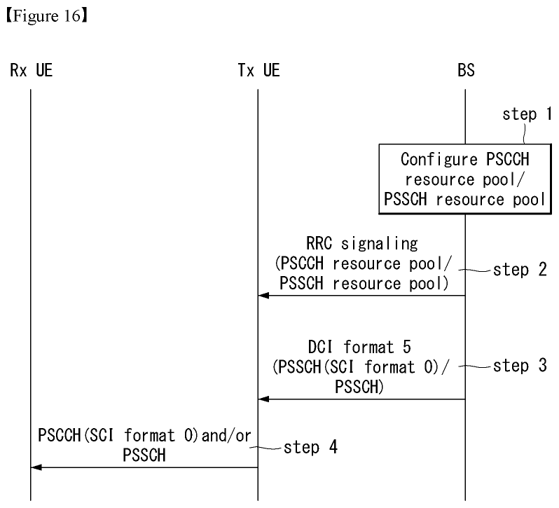

A detailed example of the sidelink communication Mode 1/Mode 3 and a signaling process are as the following FIGS. 15 and 16. In this case, as described above, control information related to the sidelink communication is transmitted through a PSCCH and data information related to the sidelink communication is transmitted through a PSSCH.

FIG. 15 shows a method of performing a sidelink operation process and sidelink communication by transmitting/receiving relevant information in the sidelink communication Mode 1/Mode 3 by control of a BS.

As shown in FIG. 15, a PSCCH resource pool 610 and/or a PSSCH resource pool 620 that are related to sidelink communication may be configured in advance, and the resource pools configured in advance can be transmitted from a BS to sidelink UEs through RRC signaling. In this case, the PSCCH resource pool and/or the PSSCH resource pool may mean resources reserved for sidelink communication (i.e., dedicated resources). In this case, the PSCCH, which is control information for scheduling transmission of sidelink data (i.e., a PSSCH), may mean a channel through which an SCI format 0 is transmitted.

Further, the PSCCH is transmitted in accordance with a PSCCH period and the PSSCH is transmitted in accordance with a PSSCH period. Scheduling for the PSCCH is performed through a DCI format 5 and scheduling for the PSSCH is performed through the SCI format 0. The DCI format 5 may be referred to as a sidelink grant.

In this case, the DCI format 5 includes resource information for the PSCCH (i.e., resource allocation information), a transmission power control (TPC) command for the PSCCH and PSSCH, zero padding (ZP) bit(s) and some fields of the SCI format 0 (e.g., a frequency hopping flag), resource block assignment and hopping resource allocation information, and a time resource pattern (e.g., a subframe pattern).

Further, the fields of the SCI format 0, which is information related to scheduling of the PSSCH (i.e., the SCI format 0), is composed of fields such as a frequency hopping flag, a time resource pattern, an MCS (Modulation and Coding Scheme), a TA (Timing Advance) indication, and a group destination ID.

FIG. 16 shows a downlink control information transmission method for sidelink communication between UEs in a wireless communication system that support sidelink communication.

First, a PSCCH resource and/or a PSSCH resource pool related to sidelink are configured by an upper hierarchy (step 1).

Thereafter, a BS transmits information about the PSCCH resource and/or the PSSCH resource pool to a sidelink UE through upper hierarchy signaling (e.g., RRC signaling) (step 2).

Thereafter, the BS transmits control information related to transmission of the PSCCH (i.e., the SCI format 0) and/or transmission of the PSSCH (i.e., sidelink communication data) separately or together to a sidelink transmission UE (step 3). The control information includes scheduling information of the PSCCH and/or the PSSCH in the PSCCH resource pool and/or the PSSCH resource pool. For example, resource allocation information, an MCS level, a time resource pattern, etc. may be included.

Thereafter, the sidelink transmission UE transmits the PSCCH (i.e., the SCI format 0) and/or the PSSCH (i.e., sidelink communication data) to a sidelink reception UE on the basis of the information received in step 3 (step 4). In this case, transmission of the PSCCH and transmission of the PSSCH may be performed together or, transmission of the PSSCH may be performed after transmission of the PSCCH.

Meanwhile, though not shown in FIG. 16, the sidelink transmission UE can request a transmission resource (i.e., a PSSCH resource) for sideling data from the BS and the BS can schedule resources for transmission of the PSCCH and PSSCH. To this end, the sidelink transmission UE transmits a scheduling request (SR) to the BS and then a BSR (Buffer Status Report) process of providing information about the amount of resources requested by the sidelink transmission UE to the BS can be performed.

The reception UEs monitors the control information pool, and can selectively decode sidelink data transmission related to corresponding control information by decoding control information related to themselves, respectively.

In contrast, the Mode 2/Mode 4 refers to a manner that randomly selects a specific resource from a resource pool to transmit data or control information for sidelink communication. The Mode 2/Mode 4 is applied in out-of-coverage and/or in-coverage.

A resource pool for control information transmission and/or a resource pool for sidelink communication data transmission may be pre-configured or semi-statically set. A UE is provided with the set resource pools (time and frequency) and selects a resource for sidelink communication transmission from the resource pools. That is, a UE can select a resource for control information transmission from a control information pool to transmit control information. Further, the UE can select a resource from a data resource pool for sidelink communication data transmission.

Further, in sidelink broadcast communication, the control information is transmitted by a broadcasting UE. The control information shows the position of a resource for data reception in relation to a physical channel (i.e., the PSSCH) carrying sidelink communication data.

Sidelink Synchronization

A sidelink synchronization signal/sequence (SS) may be used for a UE to acquire time-frequency synchronization. In particular, in the out-of-coverage, control of a BS is impossible, so new signal and process for synchronization establishment between UEs may be defined.

A UE that periodically transmits a sidelink synchronization signal may be referred to as a sidelink synchronization source, etc.

Each UE may have several physical-layer sidelink synchronization identities. A predetermined number (e.g., 366) of physical-layer sidelink synchronization identities are defined for sidelink.

The sidelink synchronization signal includes a primary sidelink synchronization signal (PSSS) and a secondary sidelink synchronization signal (SSSS).

Before transmitting a sidelink synchronization signal, a UE can search for a sidelink synchronization source first. Further, when a sidelink synchronization source is searched, the UE can acquire time-frequency synchronization through the sidelink synchronization signal received from the searched sidelink synchronization source. Further, the corresponding UE can transmit the sidelink synchronization signal.

Further, there may be a need for a channel for transmitting system information and synchronization-related information that are used for communication between UE together with synchronization, and the channel may be referred to as a physical sidelink broadcast channel (PSBCH).

V2X communication includes communication between a vehicle and all entities such as V2V (Vehicle-to-Vehicle) referring to communication between vehicles, V2I (Vehicle to Infrastructure) referring to communication between a vehicle and an eNB or an RSU (Road Side Unit), V2P (Vehicle-to-Pedestrian) referring to communication between a vehicle and a UE that an individual (a pedestrian, a bicycle rider, a driver or a passenger in a vehicle) has, and V2N (vehicle-to-network).

V2X communication may refer to the same meaning as V2X sidelink or NR V2X or may refer to a wider meaning including V2X sidelink or NR V2X.

V2X communication may be applied to various services, for example, front collision warning, an automatic parking system, cooperative adaptive cruise control (CACC), control loss warning, traffic line warning, traffic vulnerable person safety warning, emergency vehicle warning, speed warning when driving on a bending road, and traffic flow control.

V2X communication can be provided through a PC5 interface and/or a Uu interface. In this case, in a wireless communication system that supports V2X communication, specific network entities for supporting communication between the vehicle and all entities may exist. For example, the network entities may be a BS (eNB), an RSU (road side unit), an application server (e.g., traffic safety server), or the like.

Further, a UE that performs V2X communication may mean not only a common handled UE, but also a robot including a vehicle UE (V-UE), a pedestrian UE, a BS type (eNB type) RSU, a UE type (RSU), or a communication module, etc.

V2X communication may be directly performed between UEs or may be performed through the network entity (entities). A V2X operation mode can be classified in accordance with the performance manner of V2X communication.

V2X communication is required to support pseudonymity and privacy of a UE when using V2X applications such that an operator or a third part cannot track UE identity in an area where V2X is supported.

Terms that are frequently used in V2X communication are defined as follows.
RSU (Road Side Unit): An RSU is a V2X service-enabled device that can perform transmission/reception to/from a moving vehicle using a V2I service. Further, the RSU, which is a fixed infra entity supporting V2X applications, can exchange messages with another entity supporting the V2X applications. The RSU is a term that is frequently used in an existing ITS spec and the reason of introducing this term in a 3GPP spec is for enabling easily reading documents in an ITS industry. The RUS is a logical entity that combines an V2X application logic with the function of a BS (referred to as a BS-type RUS) or a UE (referred to as a UE-type RSU).
V2I service: A type of V2X service and an entity of which a side pertains to a vehicle and the other side pertains to an infrastructure.
V2P service: A type of V2X service in which a side is vehicle and the other side is a device that an individual has (e.g., a mobile UE device that a pedestrian, a bicycle rider, a driver, or a passenger carries).
V2X service: A 3GPP communication service type in which a transmission or reception device is related to a vehicle.
V2X-enabled UE: A UE supporting a V2X service.
V2V service: A V2X service type in which both sides of communication are vehicles.
V2V communication range: A direct communication range of two vehicles participating in a V2V service.

As V2X applications called V2X (Vehicle-to-Everything), as described above, there are four types of (1) vehicle-to-vehicle, (2) vehicle-to-infra, (3) vehicle-to-network (V2N), and (4) vehicle-to-pedestrian (V2P).

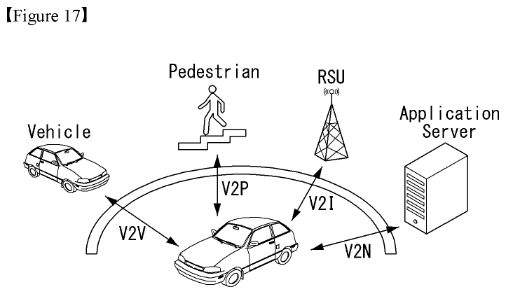

FIG. 17 shows an example of types of V2X applications.

These four types of V2X applications can use “co-operative awareness” that provide more intelligent services for the final user. This means that it is possible to collect knowledge about a corresponding area environment (e.g., information received from an adjacent another vehicle or sensor equipment) such that entities such as a vehicle, a roadside infrastructure, an application server, and a pedestrian process and share corresponding knowledge to provide more intelligent information such as cooperative collision warning or autonomous driving.

These intelligence transport service and relevant message sets are defined in out-of-3GPP vehicle SDO (Standards Developing Organizations).

Three fundamental class road safety for providing ITS service: road safety, traffic efficiency, and other applications are, for example, described in ETSI TR 102 638 V1.1.1: “Vehicular Communications; Basic Set of Applications; Definitions”.

A radio protocol architecture for a user plane for V2X communication and a radio protocol architecture for a control plane for V2X communication may be fundamentally the same as a protocol stack architecture for sidelink (see FIG. 38). The radio protocol architecture for a user plane may include PDCP (Packet Data Convergence Protocol), RLC (Radio Link Control), MAC (Medium Access Control), and physical (PHY) layers, and the radio protocol architecture for a control plane may include RRC (radio resource control), RLC, MAC, and physical layers. 3GPP TS 23.303, 3GPP TS 23.285, and 3GPP TS 24.386 may be referred for more detailed description about the protocol stack for V2X communication.

The 5G communication technology described above can be applied in combination with methods proposed in the present disclosure to be described below or can be added to make the technical characteristics of the methods proposed in the present disclosure embodied or clear.

Recently, due to popularization of mobile device, portable device, etc., there is a problem in that many accidents occur due to instantaneous careless paying attention to the road of drivers due to mobile device while driving.

The present disclosure, in order to solve the problem, proposes a method that can prepare against a sudden dangerous situation due to careless paying attention to the road of a driver, etc., by sensing a driver's gaze and displaying a situation ahead of a vehicle (road situation, etc.) on a mobile device when a notice (call, text, various application notices, etc.) is generated on the mobile device while driving a vehicle.

Further, a driver can use the method proposed in the present disclosure without a specific additional setting procedure except for the initial setting of a mobile device and the method proposed in the present disclosure is directly associated with the safety of a driver, so there is an effect in that accidents related to vehicles can be reduced.

Hereafter, embodiments in which methods proposed in the present disclosure can be implemented are described.

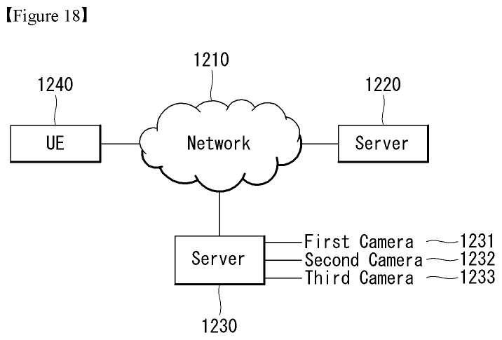

FIG. 18 is an example of a system configuration diagram to which a method proposed in the present disclosure can be applied.

Referring to FIG. 18, a system for displaying a vehicle driving situation that is proposed in the present disclosure may be composed of a network 1210, a vehicle 1230, and a UE (User Equipment) 1240, and, depending on cases, a server 1220 may be added.

In this configuration, the network 1210 ay be a 5G network using the 5G technology described above, and various items of information (data) can be transmitted/received among the vehicle 1230, the UE 1240, and the server 1220 using the 5G communication described above.

The vehicle 1230 may be equipped with a first camera 1231, a second camera 1232, and a third camera 1233, in which the first camera 1231 can be used to sense the position of the UE 1240, the second camera 1232 can be used to acquire in real time an outside image of the vehicle 1230, and the third camera 1233 can be used to sense the gaze direction of a driver who drives the vehicle 1230.

The server 1220 can be connected with the vehicle 1230 and the UE 1240 using the network 1210, can receive and store outside images acquired by the second camera 1232, and can transmit the outside image to the UE 1240.

Further, the server 1220 can store outside images of another vehicle received from the another vehicle and can also transmit the outside images of the another vehicle to the UE 1240.

The UE 1240, which is a device that displays outside images transmitted from the server 1220 on the screen of the UE 1240, may mean a device including a screen that can display images such as various mobile devices (e.g., a smartphone, a PDA (personal digital assistants), a PMP (portable multimedia player), a wearable device (e.g., a smart watch and an HMD (head mounted display), and a navigation installed in a vehicle.

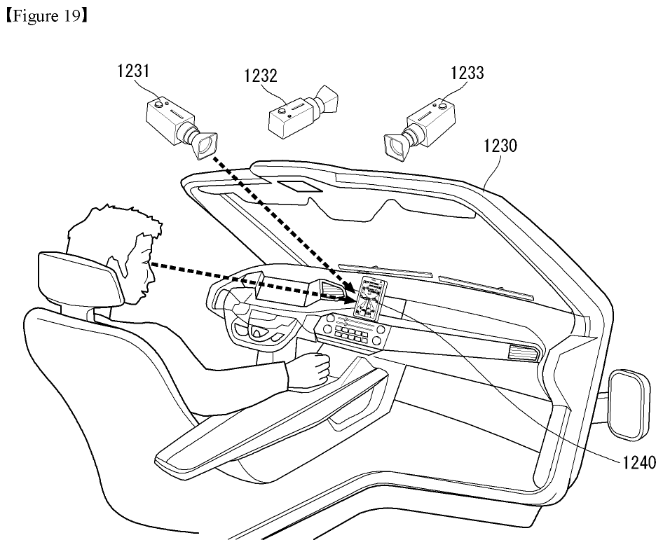

Hereafter, a detailed method of displaying a driving situation of the vehicle 1230 on the screen of the UE 1240 using the system is described with reference to FIGS. 19 to 22.

FIG. 19 is a diagram showing an embodiment of sensing a gaze direction of a driver to which a method proposed in the present disclosure is applied.

Here, the UE 1240, other than the position shown in FIG. 19, may be installed in a vehicle within a range that a driver's gaze reaches and the UE 1240 may be positioned in accordance with convenience of a driver.

Similarly, the first, second, and third cameras 1231, 1232, and 1233 may also be installed at positions other than the positions shown in FIG. 19.

Referring to FIG. 19, the first camera 1231 can sense the position of the UE 1240 positioned in the vehicle 1230. The arrow starting from the first camera 1231 in FIG. 19, which is one of several gaze directions for the first camera 1231 to sense the UE 1240, may mean a gaze direction from the first camera 1231 to the UE 1240 after the first camera 1231 senses the UE 1240.

The third camera 1233 can sense the gaze direction of a driver in the vehicle 1230. The arrow starting from the driver in FIG. 19, which is a gaze direction of the driver, may mean the gaze of the driver looking at the UE 1240.

In this case, when the UE 1240 is positioned in the gaze direction of the driver, it is possible to determine that the driver is looking at the screen of the UE 1240.

In detail, when the position of the UE 1240 that the first camera 1231 founds out by sensing the UE 1240 is positioned on a gaze direction line of the driver, it is possible to determine that the driver is looking at the UE 1240 to check a notice, etc. of the UE 1240.

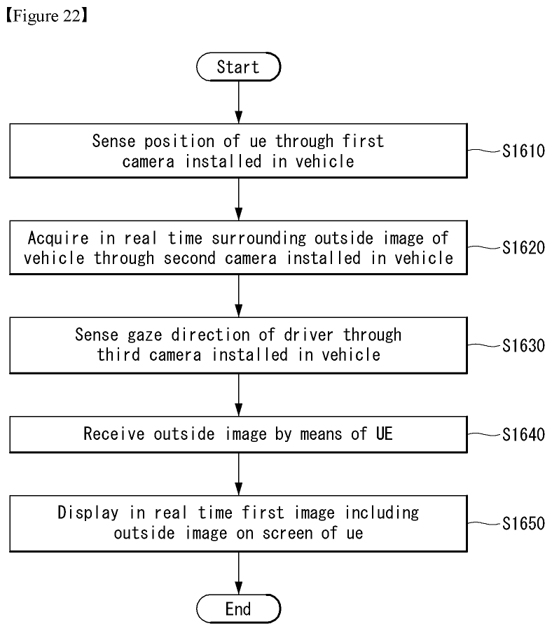

FIG. 22 is a diagram showing an embodiment to which a method proposed in the present disclosure is applied.

First, it is possible to sense the position of the UE 1240 through the first camera 1231 installed in the vehicle 1230 (S1610).

In this case, it is possible to use not only the first camera 1231, but also a beacon installed in the vehicle 1230 and a multi camera of the UE 1240 in order to sense the position of the UE 1240.

Next, it is possible to acquire in real time surrounding outside images of the vehicle 1230 through the second camera 1232 installed in the vehicle 1230 (S1620).

In this case, the surrounding outside images of the vehicle 1230 may be images taken from the front area, sides, and/or the rear area and the second camera 1232 for acquiring the surrounding outside images may be a black box camera installed on the front, sides, and/or rear of the vehicle 1230 or may be a front, side, and/or rear camera attached to the vehicle 1230.

Next, it is possible to sense the gaze direction of the driver through the third camera 1233 installed in the vehicle 1230 (S1630).

In other words, it is possible to sense whether the gaze direction of the driver is directed toward the UE 1240. In this case, in order to sense the gaze direction of the driver, the position of the UE 1240 sensed in step S1610 may be additionally considered.

In consideration of the gaze direction of the driver and the position of the UE 1240, it is possible to use the method described above and shown in FIG. 19 in respect of whether the driver is looking at the UE 1240.

Next, the UE 1240 can receive the outside image (S1640).

Before step S1640, the second camera 1232 can transmit the acquired outside image to the server 1220 and the server 1220 can store the received outside image.

Further, the outside image received in step S1640 is an outside image stored in the server 1220 and can be received from the server 1220.

Thereafter, it is possible to display in real time a first image including the outside image on the screen of the UE 1240 (S1650).

That is, the UE 1240 can receive the first image including the outside image in real time and display an image the same as the actual driving situation.

Step S1650 may be performed when the UE is positioned in the gaze direction of the driver in step S1630 and the outside images displayed on the screen of the UE 1240 may be images taken from the front area, side areas, and rear area of the vehicle 1230 and acquired in step S1620.

For example, when the driver temporarily looks at a phone screen in order to see a sudden alarm (a text, a call, an application notice, etc.) or a game or a movie on the UE 1240 while driving, cameras (e.g., the first camera 1231, the second camera 1232, and the third camera 1233) or the UE 1240 sense and track the driver's gaze, and when it is sensed that the driver is looking at a surface of the UE 1240, an outside image can be immediately displayed on the screen of the UE 1240.

Further, the outside image of the displayed first image may be set on the basis of the driving direction of the vehicle 1230, and for example, when the vehicle 1230 is moved backward and the driver's gaze is directed to the UE 1240, a rear image can be displayed on the screen.

Further, as the image displaying the first image, an application execution image of the UE 1240 may be further included, in which the configuration in which the outside image and the application execution image are displayed may be different, depending on the number of the screen of the UE 1240.

For example, when it is sensed that the gaze direction of the driver is directed to the UE 1240, a front image can be displayed on the screen in a common driving situation of the vehicle 1230; when the vehicle 1230 is parked and is moved backward to take out the vehicle 1230, a rear image can be displayed on the screen; and when lanes are changed, a side image can be displayed on the screen.

Further, step S1610 may be a step of additionally sensing whether the screen of the UE 1240 is directed to the driver, in addition to sensing the position of the UE 1240. This is because when the first image is displayed on the screen, the driver can check the first image and can smoothly cope with a dangerous situation.

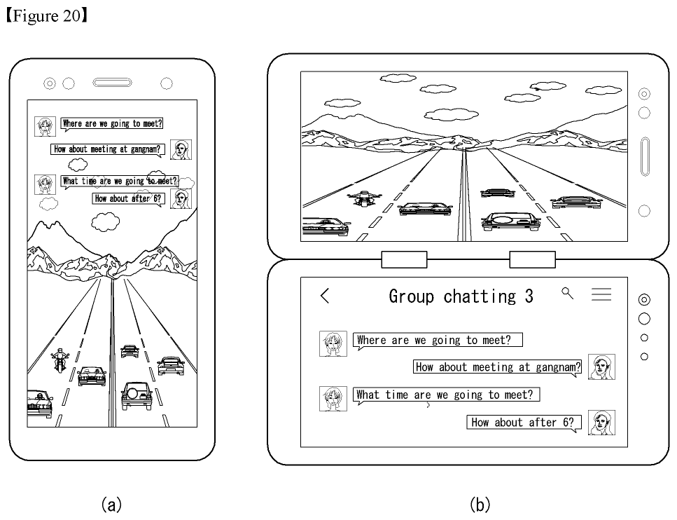

FIG. 20 is a diagram showing an example of displaying a driving situation proposed in the present disclosure on the screen of a UE.

For example, as in FIG. 20(1), when the number of screen of the UE 1240 is one, the outside image and the application execution image can be displayed with different transparencies, and when the number of screen is two, as in FIG. 20(b), the outside image can be displayed through a first screen and the application execution image can be displayed through a second screen, whereby the can be separately displayed.

As shown in FIG. 20(a), the images can be displayed to overlap each other with the transparency of the application execution image higher than that of the outside image so that the driver can more quickly cope with a sudden dangerous situation through the outside image.

The transparency can be adjusted to numerical values that a user wants through the UE 1240, and to this end, the UE 1240 can provide a specific control image (e.g., a scroll bar).

Further, a dangerous situation about the vehicle 1230 may be sensed through the second camera 1232 or sensing sensors installed inside/outside the vehicle 1230.

In this case, the dangerous situation can be displayed on the screen of the UE 1240 and the dangerous situation may be additionally included and displayed in the first image.

In detail, a dangerous situation may be one set in advance, and determining whether it is a dangerous situation may be performed through the UE 1240 or may be performed by a specific AP (Access Point) installed in the vehicle 1230 or a specific cloud server.

In this case, in order to determine whether it is a dangerous situation, an AI algorithm based on an outside image of the vehicle 1230, etc. may be used.

The set dangerous situation may be a case when a traffic light has changed to the red light, a case when a specific object approaches within a predetermined distance outside the vehicle 1230, a case when the vehicle 1230 goes out of the driving lane, etc.

In this case, the specific object may be another vehicle, a person, a kick board, a bicycle, a motor cycle, etc.

In order to determine what the specific object is, an outside image of the vehicle 1230, etc. can be transmitted to a specific AP installed in the vehicle 1230, a cloud server, etc., and the AP, the cloud server, etc. can detect a specific object or perform segmentation using computing resources.

As an example of the dangerous situation, a case when another vehicle approaching from the rear area approaches without slowing down, a case when a person, a bicycle, a motor cycle, etc. pass behind the vehicle 1230, etc. with the driver stops to stands by a traffic signal may be set as a dangerous situation.

When such a dangerous situation is additionally displayed in the first image, it can be specially highlighted and displayed.

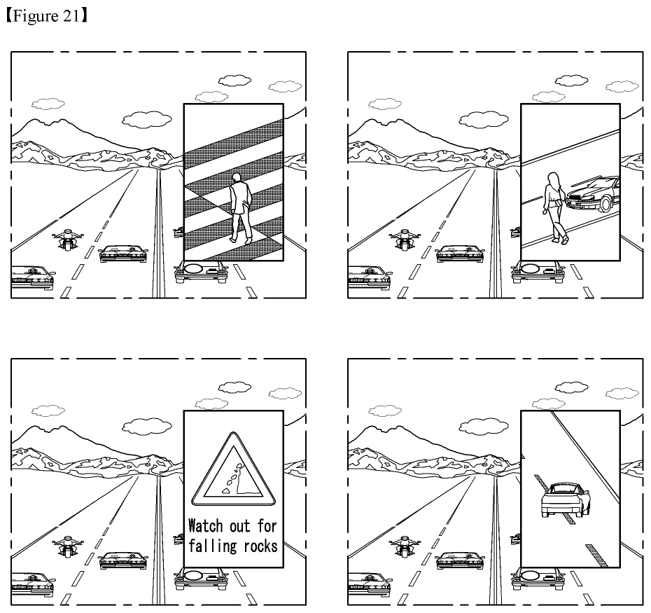

FIG. 21 is a diagram showing an example of dangerous situation expression displayed on a UE in which a method proposed in the present disclosure is performed.

As shown in FIG. 21, a dangerous situation, etc. can be preferentially highlighted and displayed before a common driving situation.

As an example of this dangerous situation, there may be a case when a person passes a roadway, that is, a case when a person passes through a crosswalk and a case when a person jaywalks.

In addition, it is possible to sense and highlight other specific situations other than a person, that is, there may be a case when a sign (e.g., ‘watch out for falling rocks’, ‘slow’, etc.) shows up while a vehicle is driven and a case when another vehicle changes lanes (e.g., passes, goes over the center line, etc.) while the vehicle is driven.

Other than the examples shown in FIG. 21, it is possible to sense and highlight several situations.

Such highlighting may be an expression set in advance, and in detail, when a red right of a traffic light is turned on, the first image can be entirely displayed with red and the specific object can be displayed in a half or more size of the screen size of the UE 1240. In addition, it is possible to determine which direction the specific object approached in with respect to the vehicle 1230 and to display indication about the direction (e.g., the front, side, rear external appearance of a vehicle or a specific text sentence) in a first image and it is possible to display what dangerous situation it is (e.g., traffic signal violation, lane violation, approach of a specific object, etc.) in a first image through a text sentence.

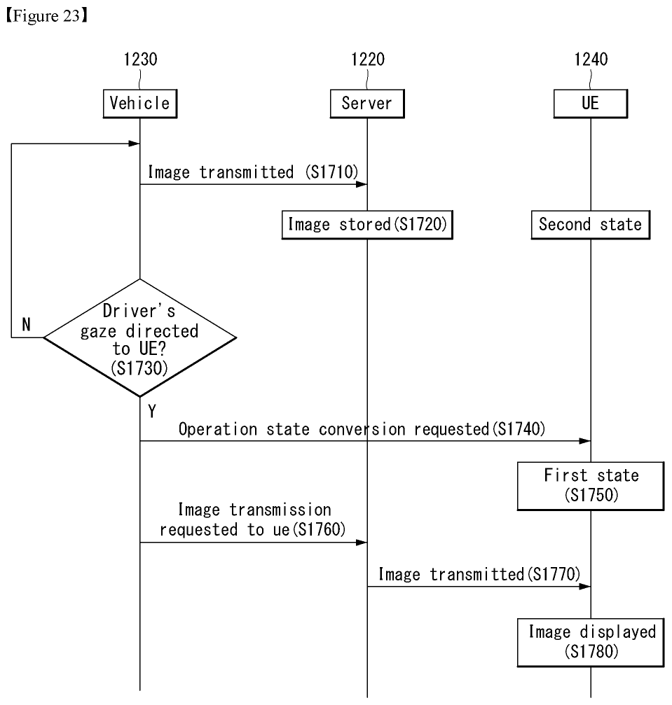

FIG. 23 is a flowchart showing a method of converting the operation state of a UE of the present disclosure.

First, the UE 1240 can be operated separately in a first state and a second state, in which the first state may mean a state for displaying the first image (e.g., a ready state and a standby state) and the second state may mean an idle state.

Referring to FIG. 23, first, the UE 1240 may be set with the second state as a fundamental operation state.

First, the vehicle 1230 can transmit an outside image of the vehicle 1230 to the server 1220 and the server 1220 can store the received outside image (S1710, S1720).

In this case, the outside image may be an image taken by the second camera 1232 installed inside or outside the vehicle 1230, as described above.

Thereafter, the vehicle 1230 can sense whether the driver's gaze is directed to the UE 1240 (S1730). In this case, the driver's gaze can be sensed through the third camera 1233 described above.

In this case, if it is sensed that the driver's gaze is not directed to the UE 1240, the vehicle 1230 can repeatedly perform step S1710 without a specific operation. However, when it is sensed that the driver's gaze is directed to the UE 1240, the vehicle 1230 can give an operation state conversion request that changes the operation state to the UE 1240 and the UE 1240 receiving the request can convert the operation state into the first state.

That is, the UE 1240 converts into a state for receiving an outside image taken by the vehicle 1230 from the server 1220 and displaying the outside image on the screen.

Thereafter, the vehicle 1230 requests the server 1220 to transmit the outside image to the UE 1240 and the server 1220 receiving the request transmits the outside image to the UE 1240 (s1760, S1770).

Thereafter, the UE 1240 can display the received outside image through the screen of the UE 1240 (S1780).

In this case, in the image that is displayed through the screen, the application execution image or an image about a specific dangerous situation may be additionally displayed, and the detailed operation for display is the same as the method described above.

That is, when the driver's gaze is not directed to the UE 1240, the UE 1240 operates in the idle state, so there is an effect in that it is possible to reduce unnecessary power consumption. That is, only when the driver looks at the UE 1240, the UE 1240 operates in the first state.

In addition, when another person (e.g., a passenger) except for the driver uses the UE 1240, it is possible not to display an unnecessary outside image so that people who do not use the UE 1240 do not feel inconvenient.

Such state conversion may be automatically performed through a change is the driver's gaze without a process such as changing the setting of the UE 1240 by the driver.

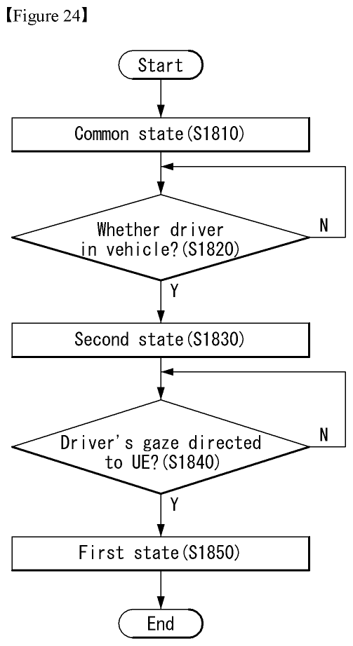

FIG. 24 is a diagram showing another embodiment of the method of converting the operation state of a UE of the present disclosure.

A method of converting the operation state of the UE 1240 is described in detail with reference to FIG. 24.

First, the first state and the second state described above may mean states in which operation is performed, depending on whether a driver has got in the vehicle 1230.

The UE 1240 may operate in a common state before a driver gets in the vehicle 1230 (S1810). That is, the common state may be considered as a normal state that is maintained for general driving of the UE 1240.

Thereafter, whether a driver has got in the vehicle 1230 is determined (S1820). In this case, for the determination, specific data can be transmitted/received through the network 1210 between the UE 1240 and the vehicle 1230.

When it is determined that a driver has got in the vehicle 1230, the UE 1240 can start operating in the second state described above (S1830). On the other hand, when a driver has not got in the vehicle 1230, the existing common state can be maintained.

Thereafter, whether the driver's gaze is directed to the UE 1240 is determined, and when it is determined that the driver's gaze is directed to the UE 1240, the UE 1240 can convert and operate into the first state described above (S1840, S1850).

As described above, when it is not determined that the driver's gaze is directed to the UE 1240 in step S1840, the UE 1240 can maintain the second state.

That is, since the operation state of the UE 1240 is changed by tracking the driver's gaze, while another person (e.g., a passenger) uses the UE 1240, an outside image is not displayed on the screen, so it is possible to prevent another person from feeling inconvenient in use of the UE 1240.

Next, a method in which the vehicle 1230 is connected with a base station and performs an initial access procedure is described.

First, a base station can perform an initial access procedure with the vehicle 1230 by periodically transmitting an SSB (Synchronization Signal Block), and can perform a random access procedure with the vehicle 1230.

Thereafter, the base station can transmit an uplink grant (UP grant) to the vehicle to schedule transmission of an outside image of the vehicle 1230.

In this case, the vehicle 1230 transmits the outside image of the vehicle 1230 to the UE on the basis of the uplink grant and the UE can display a first image including the outside image of the vehicle 1230 on the screen of the UE.

In this case, the first image may be one that is displayed when the UE is positioned in the direction of the driver's gaze, as described above.

In this case, a process of performing a downlink beam management (DL Beam Management) procedure using the SSB may be further included.

As described above, the first, second, and third cameras 1231, 1232, and 1233 may be installed in the vehicle 1230, and when information (data, an outside image, etc.) is transmitted/received between a vehicle and a base station and information is transmitted/received between the vehicle 1230 and the UE 1240, or when the initial access procedure is performed, the 5G technology described above can be applied.

It is apparent to those skilled in the art that the present disclosure can be embodied in other specific types within a range not departing from the necessary characteristics of the present disclosure. Accordingly, the detailed description should not be construed as being limited in all respects and should be construed as an example. The scope of the present disclosure should be determined by reasonable analysis of the claims and all changes within an equivalent range of the present disclosure is included in the scope of the present disclosure.

1. A method of displaying a vehicle driving situation, the method comprising:
sensing a position of a UE (User Equipment) through a first camera installed in a vehicle;
acquiring in real time a surrounding outside image of the vehicle through a second camera installed in the vehicle;
sensing a gaze direction of a driver through a third camera installed in the vehicle;
receiving the outside image by means of the UE; and
displaying a first image including the outside image in real time on a screen of the UE,
wherein the first image is displayed when the UE is positioned in the gaze direction of the driver.

2. The method of claim 1, wherein the outside image that is displayed on the screen of the UE includes at least one of a front image, a side image, or a rear image of the vehicle.

3. The method of claim 2, wherein the outside image that is displayed on the screen of the UE is determined in accordance with a driving direction of the vehicle.

4. The method of claim 1, wherein the first image further includes an application execution image of the UE, and the outside image and the application execution image of the UE are simultaneously displayed with different transparencies.

5. The method of claim 1, wherein the first image further includes an application execution image of the UE, and when the UE has a plurality of screens, the outside image is displayed on a first screen of the UE and the application execution image of the UE is displayed on a second screen.

6. The method of claim 1, wherein the UE is operated in any one of a first state displaying the first image and a second state that is an idle state, and
when it is sensed that the gaze direction of the driver is directed to the UE, the UE operates in the first state.

7. The method of claim 1, wherein the receiving of the outside image by means of the UE include:
transmitting the outside image to a server by means of the second camera; and
receiving the outside image and a second image transmitted by another vehicle from the server by means of the UE,
wherein the first image further includes the second image.

8. The method of claim 1, further comprising additionally displaying a predetermined dangerous situation in the first image on the screen of the UE using a predetermined expression when the dangerous situation is sensed.

9. The method of claim 1, wherein the sensing of a position of a UE through a first camera installed in a vehicle further includes sensing whether a direction of the screen of the UE is directed to the driver.

10. A system for displaying a vehicle driving situation, the system comprising:
a vehicle including a first camera sensing a position of a UE (User Equipment), a second camera acquiring in real time an outside image of the vehicle, and a third camera sensing a gaze direction of the driver; and
the UE receiving the outside image and displaying in real time a first image including the outside image on a screen of the UE,
wherein the first image is displayed when the UE is positioned in the gaze direction of the driver.

11. The system of claim 10, wherein the outside image that is displayed on the screen of the UE includes at least one of a front image, a side image, or a rear image of the vehicle.

12. The system of claim 10, wherein the outside image that is displayed on the screen of the UE is determined in accordance with a driving direction of the vehicle.

13. The system of claim 10, wherein the first image further includes an application execution image of the UE, and the outside image and the application execution image of the UE are simultaneously displayed with different transparencies.

14. The system of claim 10, wherein the first image further includes an application execution image of the UE, and when the UE has a plurality of screens, the outside image is displayed on a first screen of the UE and the application execution image of the UE is displayed on a second screen.

15. The system of claim 10, wherein the UE is operated in any one of a first state displaying the first image and a second state that is an idle state, and
when it is sensed that the gaze direction of the driver is directed to the UE, the UE operates in the first state.

16. The system of claim 10, further comprising a server receiving the outside image and a second image transmitted by another vehicle from the second camera,
wherein the UE is the UE that receives the outside image and the second image from the server and displays a first image including the outside image and the second image on the screen of the UE.

17. The system of claim 10, further comprising the UE additionally displaying a predetermined dangerous situation in the first image on the screen of the UE using a predetermined expression when the dangerous situation is sensed.

18. The system of claim 10, wherein the first camera is a camera that senses whether the position of the UE and the direction of the screen of the UE are directed to the driver.

19. A method of displaying a vehicle driving situation, the method comprising:
performing an initial access procedure with a vehicle by periodically transmitting an SSB (Synchronization Signal Block); performing a random access procedure with the vehicle;
transmitting an uplink grant (UP grant) to the vehicle to schedule transmission of an outside image of the vehicle;
transmitting the outside image of the vehicle to a UE (User Equipment) on the basis of the uplink grant; and
displaying in real time a first image including the outside image of the vehicle on a screen of the UE,
wherein the first image is displayed when the UE is positioned in a gaze direction of a driver.

20. The method of claim 19, further comprising performing a downlink beam management (DL Beam Management) procedure using the SSB.
